(19) United States
(12) Patent Application Publication
(10) Pub. No.: US 2016/0239918 A1
(43) Pub. Date: Aug. 18, 2016

(54) SYSTEMS AND METHODS FOR PRESENTING RELEVANT DATA TO USERS OF A FINANCIAL COMPUTER NETWORK

(71) Applicant: OPENFOLIO CORPORATION, New York, NY (US)

(72) Inventors: Hart Alexander Thomas LAMBUR, New York, NY (US); Yinon Arie RAVID, New York, NY (US)

(73) Assignee: OPENFOLIO CORPORATION, New York, NY (US)

(21) Appl. No.: 15/024,262

(22) PCT Filed: Sep. 24, 2014
(86) PCT No.: PCT/US14/57292

§ 371 Date: Mar. 23, 2016

Related U.S. Application Data
(60) Provisional application No. 61/881,702, filed on Sep. 24, 2013.

(51) Int. Cl. G06Q 40/06; G06F 17/24; G06Q 50/00; G06F 3/0481

(52) U.S. Cl. CPC G06Q 40/06; G06F 3/04817; G06F 17/241; G06Q 50/01

(57) ABSTRACT

Methods are provided for presenting users of a financial network with relevant information, based on the processing of user data that may include user financial data, user demographic data, and/or social connection data. In some embodiments, a time-dependent visualization associated with a security or index is annotated with annotations pertaining to events involving other users of the fmancial network. User cohorts may be identified, and the user cohorts may involve a correlation with a given user. Such user cohorts may be processed to generate aggregate fmancial measures. In some embodiments, user-relevant feed items are generated for display in a user interface, whereby the relevance of each the feed items in the user interface. Methods of calculating measures of financial and social similarity, and joint measures of financial and social similarity, are provided.

### CROSS-REFERENCE TO RELATED APPLICATION

This application claims priority to U.S. Provisional Application No. 61/881,702, titled “WEB BASED METHOD AND SYSTEM FOR ASSIMILATING FINANCIAL ACTIVITY IN A SOCIAL NETWORK TO OPTIMIZE A USER′S FINANCIAL DECISIONS” and filed on Sep. 24, 2013, the entire contents of which is incorporated herein by reference.

### BACKGROUND

The present disclosure relates to financial computer systems that gather and process the financial data of a collection of users. The present disclosure also relates to the financial social networks.

The advent of the internet has led to the generation and preservation of large and rich databases filled with pertinent financial information. Despite this, the levels of noise, useless or irrelevant information, that an investor or trader encounters in the current online environment relative to the amount of good signals, useful and relevant financial information, is a growing problem that affects a majority of investors seeking financial advice or information online. Noise not only consumes a great deal of time but can often hurt an investor's decision-making. An example embodiment of the present disclosure aims to organize information, news and advice based on a comparison of the financial transactions of a user as well as their social network in order to improve the sub-optimal signal to noise ratio encountered when querying the internet.

Many web-based solutions for the abovementioned problem currently exist. Seeking Alpha is a news-based platform that collects a list of stock tickers that a user selects on the basis that the user would prefer to get information about those particular companies and the server then organizes and ranks news for each user based on their preferences. The site compares similar user's preferences in order to further suggest news articles and investment advice based on social similarities.

Amazon operates as a web-based system which collects consumer historical transaction data and uses similarity comparisons in order to offer relevant suggestions to a user for future consumption. Users' are effectively profiled by a set of weighted consumer parameters which function on past purchases and item interest revealed by browsing habits. Users are then suggested consumer products that they would most likely prefer based on other “similar” users' preferences. This system also helps to solve the abovementioned problem of a poor signal to noise ratio.

In the modern financial world, it is difficult to find trustworthy information. The problem is exacerbated by the internet as the computer provides an additional degree of personal disconnect between those providing advice in the form of articles or blogs. Businessweek, CNBC, Seeking Alpha, Yahoo Finance, Motley fool and Marketwatch are examples of sites that suffer from this disconnect. It is very difficult to determine the interests of an author of a financial article or news item. More specifically, it is difficult for a user to determine if his or her interests are aligned with those of the author, despite the fact that the authors are required to provide a disclaimer revealing their recent positions in the stocks mentioned in the article.

### SUMMARY

Methods are provided for presenting users of a financial network with relevant information, based on the processing of user data that may include user financial data, user demographic data, and/or social connection data. In some embodiments, a time-dependent visualization associated with a security or index is annotated with annotations pertaining to events involving other users of the financial network. User cohorts may be identified, and the user cohorts may involve a correlation with a given user. Such user cohorts may be processed to generate aggregate financial measures. In some embodiments, user-relevant feed items are generated for display in a user interface, whereby the relevance of each feed item to a given user may be evaluated to order the feed items in the user interface. Methods of calculating measures of financial and social similarity, and joint measures of financial and social similarity, are provided.

Accordingly, in a first aspect, there is provided a computer implemented method of annotating a time-dependent visualization associated with a financial security with information associated with transactions executed by users of a financial social network, the method comprising:

receiving input obtained from an active user of the financial social network, the input identifying a selected security;

accessing user transaction data associating transactions with users of the financial social network;

processing the user transaction data to identify one or more matching transactions involving the selected security, wherein each matching transaction is associated with a respective matching user;

generating annotated time-dependent visualization data based on the one or more matching transactions for rendering an annotated time-dependent visualization associated with the selected security on a user interface associated with the active user, such that the annotated time-dependent visualization includes one or more graphical annotations representative of the one or more matching transactions.

In another aspect, there is provided a computer implemented method of annotating a time-dependent visualization of a financial security with information associated with transactions executed by users of a financial social network, the method comprising:

receiving input from a computing device associated with an active user of the financial social network, the input identifying a selected security to be displayed;

accessing user transaction data associating transactions with users of the financial social network;

processing the user transaction data to identify one or more matching transactions involving the selected security, wherein each matching transaction is associated with a respective matching user of the financial social network;

transmitting matching transaction data comprising the matching transactions and the associated matching users to the computing device associated with the active user for rendering the annotated time-dependent visualization on the user interface.

In another aspect, there is provided a computer readable medium containing program instructions for annotating a time-dependent visualization associated with a financial security with information associated with transactions executed by users of a financial social network, wherein execution of the program instructions by one or more processors of a computer system causes the one or more processors to carry out the steps of:

receiving input obtained from an active user of the financial social network, the input identifying a selected security;

accessing user transaction data associating transactions with users of the financial social network;

processing the user transaction data to identify one or more matching transactions involving the selected security, wherein each matching transaction is associated with a respective matching user;

generating annotated time-dependent visualization data based on the one or more matching transactions for rendering an annotated time-dependent visualization associated with the selected security on a user interface associated with the active user, such that the annotated time-dependent visualization includes one or more graphical annotations representative of the one or more matching transactions.

In another aspect, there is provided a computer implemented method of annotating a time-dependent visualization associated with a financial index with information associated with transactions executed by users of a financial social network, the method comprising:

receiving input obtained from an active user of the financial social network, the input identifying a selected financial index;

accessing user transaction data associating transactions with users of the financial social network;

processing the user transaction data processing the user transaction data to identify one or more matching transactions involving the selected financial index, wherein each matching transaction is associated with a respective matching user of the financial social network;

wherein the financial index comprises a plurality of financial securities, and wherein the one or more matching transactions involve one or more financial securities of the plurality of financial securities; and

generating annotated time-dependent visualization data for rendering an annotated time-dependent visualization associated with the selected financial index on a user interface associated with the active user, wherein the annotated time-dependent visualization data is generated based on the one or more matching transactions, such that the annotated time-dependent visualization includes one or more graphical annotations representative of the one or more matching transactions.

In another aspect, there is provided a computer implemented method of annotating time-dependent visualization of a financial security with information associated with transactions executed by users of a financial social network, the method comprising:

receiving input from an active user of the financial social network, the input identifying a selected security;

sending a request to a server, the request to provide matching transaction data associating one or more matching transactions involving the selected security with a respective matching user of the financial social network;

receiving the matching transaction data;

generating annotated time-dependent visualization data for rendering an annotated time-dependent visualization associated with the selected security on a user interface associated with the active user, wherein the annotated time-dependent visualization data is generated based on the matching transaction data, such that the annotated time-dependent visualization includes one or more graphical annotations representative of the one or more matching transactions; and

rendering the annotated time-dependent visualization on the user interface.

In another aspect, there is provided a computer implemented method of annotating a time-dependent visualization of a financial security with information associated with transactions executed by users of a financial social network, the method comprising:

receiving input from an active user of the financial social network, the input identifying a selected security;

sending a request to a server, the request to provide annotated time-dependent visualization data associated with the selected security for rendering on an annotated time-dependent visualization on user interface, wherein the annotated time-dependent visualization data is generated by processing user transaction data to identify one or more matching transactions involving the selected security, wherein each matching transaction is associated with a respective matching user, such that the annotated time-dependent visualization includes one or more graphical annotations representative of one or more matching transactions;

receiving the annotated time-dependent visualization data from the server; and

rendering the annotated time-dependent visualization on the user interface.

In another aspect, there is provided a computer implemented method for generating one or more aggregate financial measures associated with a specific user of a financial computer system, the method comprising:

accessing a computer database comprising portfolio data and user profile data associated with each of user of the financial computer system;

processing at least one of the portfolio data and the user profile data to identify a subset of correlated users that satisfy at least one user-specific criterion associated with the specific user, wherein the at least one user-specific criterion involves a correlation between the specific user and other users of the financial computer system; and

processing the portfolio data associated with the subset of correlated users and generating the one or more aggregate financial measures associated with the subset of correlated users for presentation to the specific user.

In another aspect, there is provided a computer implemented method of calculating a measure of financial similarity between a first user of a financial network and an additional user of the financial network, the method comprising:

accessing, from a financial database associated with the financial network, financial data pertaining to users of the financial network;

identifying a set of financial attributes for assessing the financial similarity of the first user and the additional user;

processing the financial data to obtain a multi-element numerical representation of the set of financial attributes for each of the first user and the additional user; and

performing a similarity calculation involving each multi-element numerical representation to obtain the measure of financial similarity.

In another aspect, there is provided a computer implemented method of identifying a cohort of users of a financial network that are financially similar to a first user of the financial network, the method comprising:

calculating, for each user of a plurality of users of the financial network, a measure of financial similarity between the each user and the first user, wherein the measure of financial similarity is calculated according as described above; and

processing the measures of financial similarity to identify users having an associated measure of financial similarity that exceeds a pre-selected threshold.

In another aspect, there is provided a computer implemented method of prioritizing a plurality of feed items for display in a user interface associated with a given user of a financial network, the method comprising:

obtaining a plurality of feed items for display within the user interface;

processing each feed item to calculate a feature vector associated therewith, wherein each feature vector comprises a set of features that are calculated based relevance to the given user;

scoring each feed item according to the feature vector; and

prioritizing the display of the feed items according to their respective scores.

In another aspect, there is provided a computer implemented method for promoting an investment to one or more users of a financial network, the method comprising:

accessing one or more of financial data and demographic data associated with a user of the financial network;

identifying a set of attributes;

obtaining a multi-element numerical representation of the set of target attributes associated with the investment;

processing the one of more of the financial data and the demographic data to obtain a corresponding multi-element numerical representation of the set of attributes associated with the user;

processing the multi-element numerical representations to calculate a measure of similarity between the user and the investment;

comparing the measure of similarity to a pre-selected threshold; and

in the event that the measure of financial similarity exceeds the pre-selected threshold, transmitting, to a computing device associated with the user, a promotional message associated with the investment.

In another aspect, there is provided a A computer implemented method for promoting an investment to one or more users of a financial network, the method comprising:

accessing financial data associated with a user of the financial network and obtaining user portfolio data representative of the financial holdings of the user;

obtaining target portfolio data representative of a target portfolio that is correlated with the investment;

calculating a measure of financial similarity between the target portfolio data and the user portfolio data;

comparing the measure of financial similarity to a pre-selected threshold; and

in the event that the measure of financial similarity exceeds the pre-selected threshold, transmitting, to a computing device associated with the user, a promotional message associated with the investment.

### BRIEF DESCRIPTION OF THE DRAWINGS

FIG. 1 shows an example of how the financial social network connects with users (via computer/tablet/phone), connects with social networks (via API) and connects with a financial database at brokerage houses (either directly or via third party data provider).

FIG. 2 shows an example of how users in the financial social network have connections to one another (i.e. they are social contacts or “friends”) and that each user has their own financial history or interest (this example shows the stocks that a user own).

FIG. 3 shows an example process the user goes through while signing up to financial social network, linking their social network, creating a password, and then linking one or more brokerage accounts.

FIG. 4 shows a plurality of example data types collected and stored in the financial social network dataset in an example embodiment. Note that the “relationship” table stores social data and the position/security/topic/trade tables store information on a given user's financial history.

FIG. 5 shows an example of how a given user can use the proposed financial social network to view the financial holdings and interests of their social contacts.

FIG. 6 shows an example of how a given user can use the proposed financial social network to view the recent trade activity of his/her social contacts.

FIG. 7 shows an example of how a given user can use the proposed financial social network to view relevant stats and features of his/her social contact's portfolios.

FIG. 8 shows an example of how a user can use the proposed financial social network to view the activity of their social contact in a specific stock. In this example, the user is looking at the XYZ stock page and can see which of their social contact s have recently bought or sold XYZ stock, which of their social contacts currently own XYZ stock, and can also see on a price chart graph where their social contacts recently bot/sold XYZ stock.

FIGS. 8A-8E illustrate a one-dimensional time-dependent visualization of information associated with a security, annotated with user events, where the annotation detail is controlled via user input.

FIG. 9 shows an example of how a given user can use the proposed financial social network to see how many of their social contacts are invested in or recently traded stocks in a given topic. A given user can also see how many friends or investors in the financial social network are invested in each stock within that topic.

FIG. 10 shows an example table of a given user's stock gainers/losers which has been auto-populated by that user's financial interests found in their brokerage account.

FIG. 11 shows an example table illustrating the performance of the different sectors/topics a user owns as with the holdings auto-populated via the financial interests found in the user's brokerage account.

FIG. 12 shows an example news feed of data constructed from a combination of the trading activity and financial interests of friends and the user's own holdings.

FIG. 13 shows a flow chart of an example process for ranking, ordering, or displaying a feed of financial activity and information.

FIG. 14 shows a flow chart of an example process for calculating financial similarity.

FIG. 15 shows a flow chart of an example process for sending notifications to a user.

FIG. 16 shows an example network of devices connected to the network and server.

FIG. 17 shows an example computing device for use in association with the methods and systems of the present disclosure.

FIG. 18 is a flow chart illustrating an example method of generating a time-dependent visualization that includes annotations associated with user transaction events.

A further understanding of the functional and advantageous aspects of the disclosure can be realized by reference to the following detailed description and drawings.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub -group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

Unless defined otherwise, all technical and scientific terms used herein are intended to have the same meaning as commonly understood to one of ordinary skill in the art. Unless otherwise indicated, such as through context, as used herein, the following terms are intended to have the following meanings: As used herein, the phrase “financial social network” refers to a database of financial and social data pertaining to at least two socially-connected users.

As used herein, the terms “social contact”, “social connection”, “friend”, “friendship” and variations thereof means, in the context of “user A is user B's social contact,” that user B has elected to be socially connected with user A, or vice versa.

As used herein, the term “trade” and variations thereof means any combination of buying and/or selling a security. A trade may pertain to a real security or a fictitious security (for example, as per a simulated or gaming environment).

As used herein, the term “category” and variations thereof refers to a grouping of a plurality of securities having a common classification, such that one or more aggregate measures may be computed for a given category. Categories may be defined according to a standard classification scheme, such as by sector, or by industry. Categories may be defined according to a hierarchical scheme, such as the ICB and GCIS classification schemes. A category may be associated with a given financial sector, industry, asset class, investment theme, investment topic or other aggregation of specific financial instruments, securities, or investments. In another example, one or more categories may be defined according to user-provided metadata or tags, associating two or more securities with a given category.

As used herein, the term “security” and variations thereof means tradable asset or financial instrument. For example, a non-limiting list of different types of securities include a cash, stocks, bonds, mutual funds, real estate, corporations, ETFs, derivatives, currency instruments, and contractual rights and contracts involving financial instruments.

As used herein, the term “likes,” “agrees,” “interested in,” “follow” and variations thereof means, in the context of “user A likes X,” that user A likes, agrees with, or is otherwise interested in the specified news item, trade idea, trade activity, or comment “X”. These terms are standardized opinions of a user, for example, with regard to particular action of another user, or a news feed item, or another displayed information item. In the abovementioned example, the opinion that “user A” “likes” the specified news item, trade idea, trade activity, or comment “X” can be stored on the database and can be used to compare the user A to second user who has also input an opinion on the specified news item, trade idea, trade activity, or comment “X”.

As used herein, the term “social similarity” and variations thereof refer to the evaluation of the social similarity of two users. This similarity may be defined by simple heuristics like, for example, if the two users share a social connection within a financial network (e.g. they are “friends” with each other). Social similarity may also be defined by more complicated means, such as but not limited to factors like the number of degrees of separation between the two users or how many friends two users have in common.

As used herein, the term “financial similarity” and variations thereof refer to the evaluation of financial similarity of two users. This similarity may be defined by simple heuristics like, for example, whether the two users own the same investments, or maybe defined by more complicated “similarity” or machine learning calculations or algorithms that are understood by those skilled in the art.

As used herein, the term “similarity” and variations thereof may refer to either “social similarity” or “financial similarity” or some combination of these two similarity measures.

### Financial Network

In an example embodiment of the present disclosure, a financial network includes a database storing financial data and demographic data pertaining to a plurality of users.

Each user of network may have a unique user ID associated therewith, which is correlated or cross-referenced with the user data (financial and demographic) stored in the database.

In one example embodiment of the present disclosure, a computing device, such as a server, collects and stores the financial data and profile (demographic) data associated with each user of the financial network. The financial data may include, for example, financial history data, investment transaction history data, and data pertaining to current investments of a user. This may be achieved, for example, by importing, or receiving as input, the trade history and current investment positions from a database, which may be an external database, such as a database associated with the user's brokerage account(s). Alternatively, the financial data can be provided manually by the user. For example, a form can be provided to the user, by a remote server, to be displayed on the computer's interface, requesting that a user manually input the history of their financial transactions and current investments in a web browser or mobile app. Alternatively, the server could send a form to the user's computer to be displayed on the computer's interface requesting that the user input authentication data (i.e. a username and password) to their brokerage account and the server could then acquire and store financial activity data from the user directly by logging into a brokerage account and by scraping and transcribing the financial history information in a standardized form using a specialized API specific to that brokerage, an industry standard API like OFX (Open Financial eXchange), or by using a third party data provider like Yodlee® or Intuit®. In either example, when this financial history information is received it is converted into a table and stored in a database. The user profile data may be manually inputted by the user, or, for example, obtained from a remote server as described above (e.g. after providing credentials to support user authentication).

A simple example of such a user database data structure pertaining to the financial data could include a tabular data structure format, where the first column represents a user ID and the second column represents the ticker of a security which that user owns. For example, if User 5 owns AAPL and GOOG, the example database data structure would have two entries (5, ‘AAPL’) and (5, ‘GOOG’) in the respective columns. Additional columns may provide additional details associated with the financial holdings of the user, such as the timing and price associated with the execution of trades. In an example embodiment, financial data is collected directly from a brokerage account such that financial information is accurate and reliable.

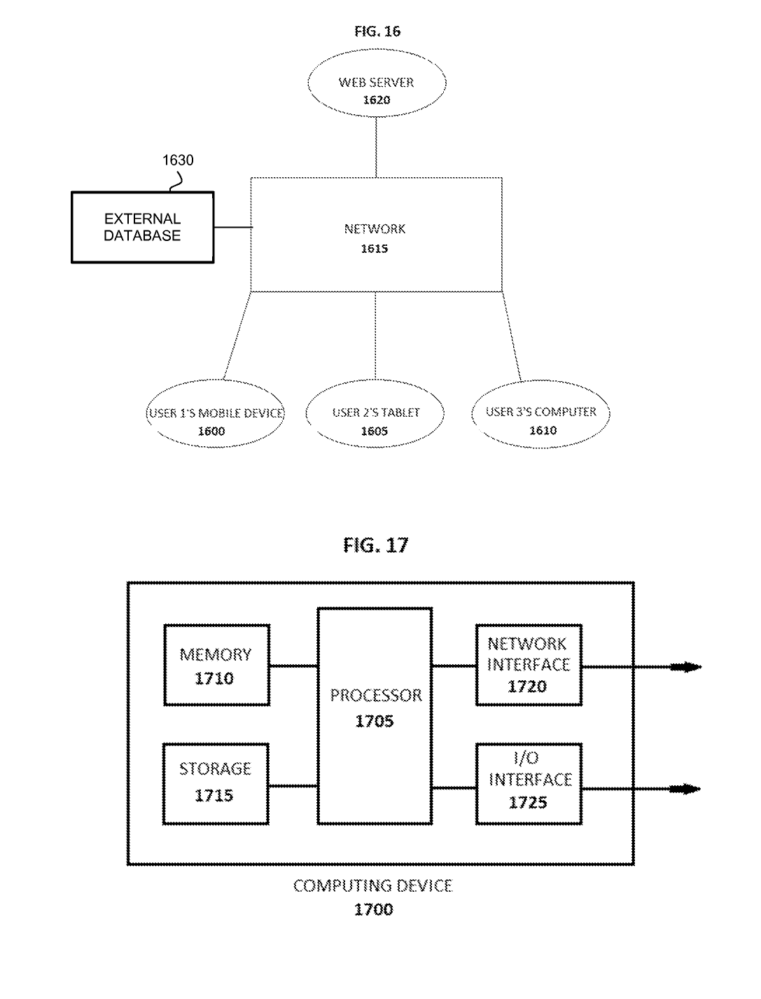

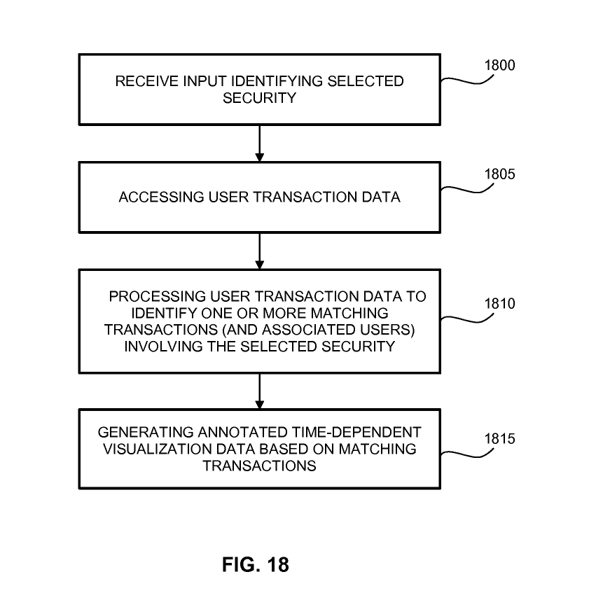

Referring now to FIG. 16, an example network is shown comprising a plurality of users 1600, 1605, 1610 connecting from a plurality of computing devices to the network 1615. The list of possible computing devices includes but is not limited to, desktop devices such as computers and laptops and mobile devices such as smartphones and tablets. Each user 1600, 1605, 1610 in the diagram can represent a plurality of users connecting from a computing device. The user's devices may transmit information between each other through the network 1615. The network 1615 can be a local network, a wide area network, the Internet or any other type of informational network. The network 1615 can be closed to only a select group of users' devices or can be open to anyone requesting to be connected. It will be understood that the components of the system can be implemented as a single system, or a geographically remote system.

The users 1600, 1605, and 1610 can, in turn, transmit information with the server 1620 through the network 1615. In general user content, financial and social information is sent from the users 1600, 1605, 1610 to be stored on the server 1620. The server 1620 can analyze and organize information stored on the database to be transmitted and displayed to users 1600, 1605, and 1610.

FIG. 16 shows an example network comprising a plurality of users 1600, 1605, 1610 connecting from a plurality of computing devices to the network 1615. The list of possible computing devices includes but is not limited to, desktop devices such as computers and laptops and mobile devices such as smartphones and tablets. Each user 1600, 1605, 1610 in the diagram can represent a plurality of users connecting from a computing device. The user's devices may transmit information between each other through the network 1615. The network 1615 can be a local network, a wide area network, the Internet or any other type of informational network. The network 1615 can be closed to only a select group of users' devices or can be open to anyone requesting to be connected. Financial, demographic, social, and other forms of data (including social media metadata, such as comments, likes, dislikes, etc.) may optionally be stored on one or more external databases, such as database 1630. An external database may be a third-party database, such as a database associated with an online brokerage.

The users 1600, 1605, 1610 can, in turn, transmit information with the server 1620 through the network 1615. In general user content, financial and social information is sent from the users 1600, 1605, 1610 to be stored on the server 1620. The server 1620 can analyze and organize information stored on the database to be transmitted and displayed to users 1600, 1605, 1610.

FIG. 17 shows an example computing device 1700 used by a user to connect and interact with the network. The computing device 1700 comprises a processor 1705. The processor 1705 can be one or a plurality of processors working together. The computing device 1700 further comprises a memory component 1710. The memory component can be one or a combination of known active memory units such as random access memory (RAM), read only memory (ROM) or other known units. The computing device 1700 further comprises a storage component 1715. The storage component can be one or more selected from the group comprising, but not limited to: a hard disk drive, a solid-state drive, a CD-ROM or DVD drive, a high-capacity low-volatile memory or a network storage device such as a “cloud” storage unit. The computing device 1700 further comprises an I/O interface 1725. The I/O interface 1725 represents all wired and wireless connections to various secondary computing devices which can be one or more selected from the group comprising, but not limited to: monitor, mouse, mobile device, touchscreen, keyboard, speaker system, kinetic feedback device and microphone. These devices may be connected via a VGA, USB, DVI, FireWire port or other known input/output ports. The computing device 1700 further comprises a network interface 1720. The network interface 1720 may comprise a wired network such as Ethernet, LAN or token ring networks and may further include access to Wide area networks and the Internet. The network interface 1720 may also comprise a wireless network such as WiFi, a network access point, wireless telephone network or satellite network.

The server, or a remote computing device that interacts with user computing devices over a network, may also have a similar structure to that shown in FIG. 17. It will be understood that the methods described herein need not be exclusively be performed by server 1620 of FIG. 16, and in some embodiments, the processing of financial, demographic and/or social data may be performed, at least in part, by a user's computing device.

The methods and systems of the present disclosure may be implemented by instructions stored in the storage 1715 of the user's computing device 1700 or the server's storage which is loaded into the active memory 1710 of the user which will further instruct the process to utilize the network 1720 and I/O interfaces 1725 to either transmit information to the network, request further content from the user or to provide information to the user. The computing device 1700 may already include software and/or hardware for providing the proper functionality to perform the network interactions described herein. A computing device may therefore include one or more of the following: logic arrays, memories, analog circuits, digital circuits, software, firmware, and processors such as microprocessors, field programmable gate arrays (FP-Gas), application specific integrated circuits (ASICs), programmable logic devices (PLDs) and programmable logic arrays (PLAs). The processes, methods and systems described herein may be embodied in part or in full to operate on a computing device described herein. They may be implemented in the form of firmware, an application program, an applet, a browser plug-in, a COM object, a dynamic linked library, a script, one or more subroutines, or an operating system component or service.

### Financial Social Network

In some example embodiments, the financial network may be configured as a financial social network, where at least one user is socially linked to at least one other user. According to such an example embodiment, the financial history and social network data are combined to form a financial social network, which may be used to share and organize financial information, for example, among socially linked users.

Various different data structures may be employed to store the user data. For example, a two-column database table or data structure may be used to store the social connections among users of the financial social network. In one example implementation, each pair of relationships among users can be represented in a columnar/tabular data structure, where the first column may represent a user (e.g. a user ID) and the second column may represent the user ID of additional users with whom the user has a social connection (i.e. friends of that user). In one example, a social network may be configured whereby a first user, “User 1”, is friends with other users, “User 5” and “User 8”. The database table would have two rows with the entries (1, 5) and (1, 8) in the two columns.

The social connection data stored within the database of the social financial network can be provided according to a wide variety of data input modalities. For example, the database could be populated by receiving input from each user, using a user interface such as a web browser or app, an indication of social relationships among contacts, for example, by clicking a “follow” or similar button. The financial social network database could also be populated by importing data from an existing social network, such as data from a users Facebook®, Linkedin®, or Twitter® network. In this scenario, the data may be obtained by receiving, from the user, authentication credientials that would provide a remote server of the financial social network with access to their existing social network via Facebook®/LinkedIn®/Twitter®'s API (Application Programming Interface). The remote server would then receiving, from these third-party social networking sites, the existing relationships in the existing social network associated with the user, and import or copy those relationships into the financial social network database.

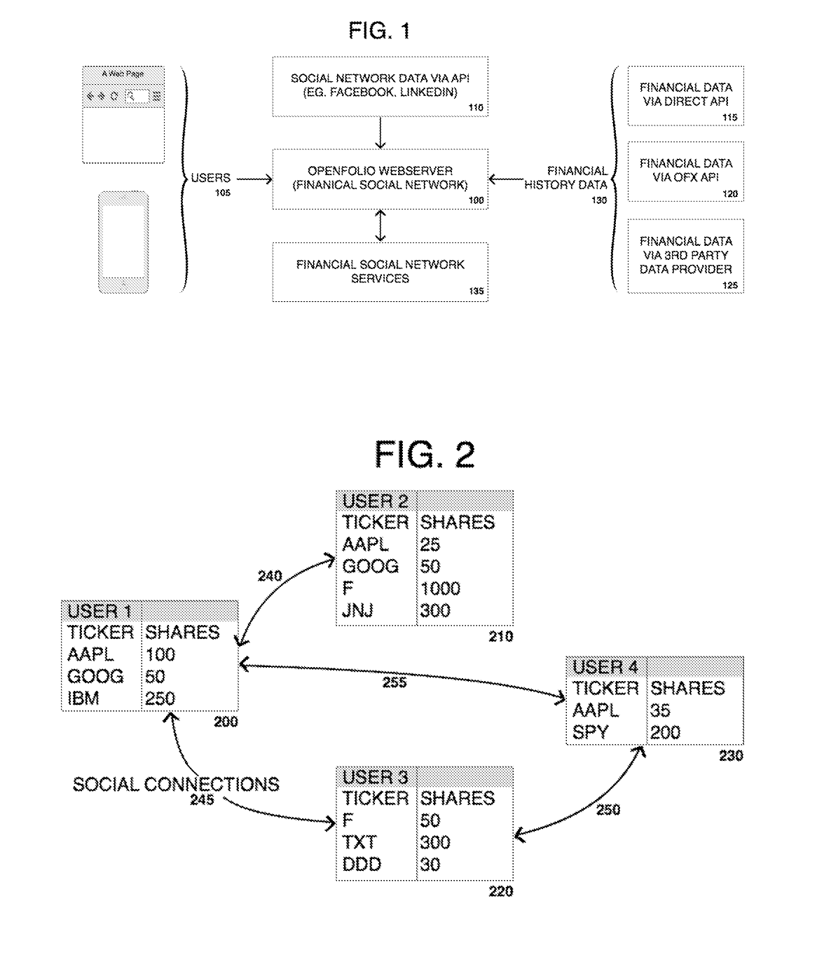

FIG. 1 shows a block diagram of an example embodiment of a computer system suitable for forming a financial social network. Server 100 (e.g. a web server) may be programmed to permit one or more users 105 to share financial information with one or more other users, systems and services based on a social relationship, or financial history.

The server 100 may be programmed to provide a form for users to input their social contacts, also herein referred to as “friendships” or “friends,” either manually via a web browser or mobile app, or automatically by a user submitting to the server 100 the authentication information to connect to an existing social network like Facebook®, Twitter® or LinkedIn® via an API 110, for example, as described above. Server 100 may be programmed to provide a form for users to input their financial history either manually via a web browser or mobile app, or automatically by linking an existing data source. An example of linking an existing data source would be linking a user's brokerage accounts (like Fidelity® or Etrade®) by the user submitting to server 100 the authentication information to access that brokerage account via an API stored in the financial history data 130, as described above. The API could be a specialized or direct API 115, an OFX API 120, or could use a third party data provider like Yodlee® or Intuit® 125 to link to a user's brokerage accounts via that third party's proprietary methodology. The server 100 may also be programmed to provide one or more related services 135 such as a service for summarizing financial news, displaying, sharing or communicating a user's social contact's financial activity, or providing investment ideas.

FIG. 2 shows an example embodiment of the present disclosure illustrating how a user's social network and financial history are combined to form a financial social network. Each example user 200, 210, 220, 230 has their own financial history or database of financial interests as shown for each user (which may be referred to below as “financial data”). In this example, the database of financial interests is a simple list of the number of shares and the tickers of each user's individual holdings, although the database could be significantly more complex and include other information such as: a list of the user's trades with time and execution price data; statistics on the user's portfolio like beta, NAV (Net Asset Value), volatility, VAR (Value At Risk), and other known ratios and quantitative measures; a list of other non-publically traded investments like real estate, automobiles, private investments; further and more detailed information of the user's current financial positions (including data like purchase date, average cost, dollar amount of holdings). FIG. 2 also shows the social connections 240, 245, 250, 255 between users of the financial social network. The links 240, 245, 250, 255 represent friendships or connections between users 200, 210, 220, 230.

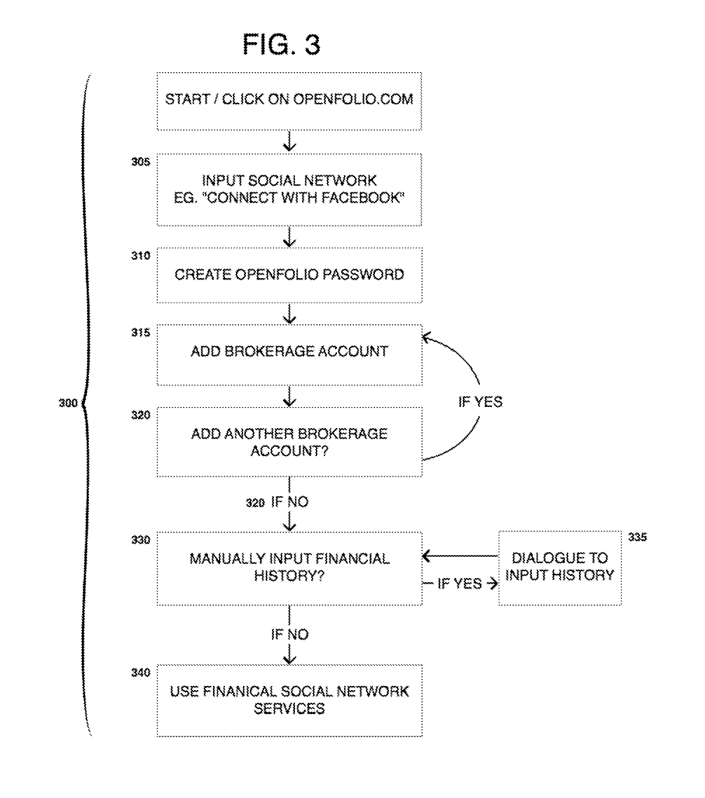

FIG. 3 shows an example computer implemented process 300 for signing up to the financial social network service. Process 300 begins where the user signs to up to the service. A website or other application (e.g. mobile device application) may be displayed to the user. At step 305, the user may be asked to connect or link to the financial social network an existing social network, such as but not limited to LinkedIn®, Facebook® or Twitter®. This may take the form of a button displayed on a website or mobile application that, when clicked, connects to an existing social network service via an API and allows the server access to the user's existing social network data. At step 310, the user may be asked to create a password for the service. At step 315, the user may be asked to input their financial history. The user may do this either manually via an interface on a web browser, or programmatically by linking an existing data source of financial interests, like a brokerage account, to the server. If the user chooses to link an existing brokerage account to the server, the user may be asked for the login name and password (and other credential information) to allow an API to access the information contained in the brokerage account, either directly or via a third party data provider, such as but not limited to Yodlee®. At step 320, the user may be asked to link another brokerage account to the server, and complete the process described in step 315 again. At step 330, the user may be asked to manually input their financial history. If the user chooses to manually input this history, they may be presented with a dialogue to input this information 335. At step 340, after having entered both their financial history and their social network, the user may now use the various services offered by the financial social network service. It will be appreciated that all the steps shown in the process 300 may not be conducted in the order shown. It will also be appreciated that not all the steps shown in the process 300 may not all be needed. Financial history and social networks are stored on the server's database.

### Example Data Structures for Storing User Financial, Profile and Social Data

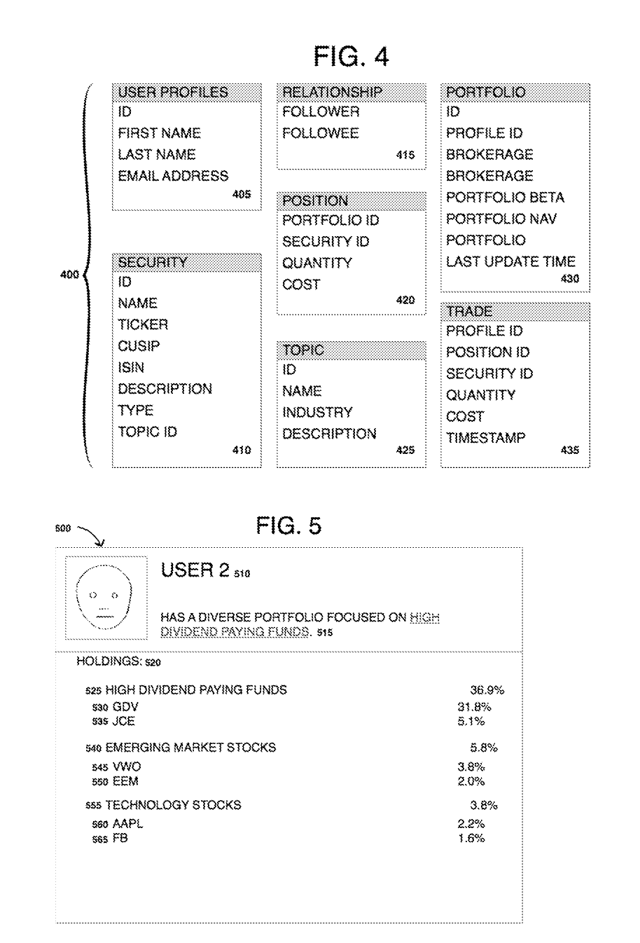

FIG. 4 shows a block diagram of an example of one implementation of a database 400 in accordance with an example embodiment of the present disclosure's server 100. The database 400 may be provided, for example, as a database management system (DBMS), an object-oriented database management system (ODBMS), a relational database management system (e.g. DB2®, ACCESS®, Postgres®, MySQL®, etc.), a no SQL database management systems (e.g. NoSQL, MongoDB®) or another conventional database package. Thus, the database 400 can be implemented using object-oriented technology or via text files. Further, the database 400 may be accessed via Structured Query Language (SQL) or other tools known to one of ordinary skill in the art.

Several types of information are shown in the example implementation of the database 400 shown in FIG. 4. The types of information include descriptive data, financial data, relationship data, and other data items. Element 405 describes an example database table to hold descriptive data on user profiles. This data contains profile or demographic information, such as an ID for each user profile entry, first and last name, email address, profile photo, among other information.

Element 415 describes an example database table to hold social relationship data. This example table takes the form of a two column table where each row in the table represents a relationship, friendship or connection between two users.

Element 410 describes an example database table to hold security data. This data contains information on investable securities such as security name, ticker, CUSIP among other information. The database may also link one or more securities one or more categories.

Element 430 describes an example database table to hold portfolio data. Portfolio data includes information to describe a portfolio of securities, and includes fields such as a profile ID (to relate the portfolio back to a user's profile), and other descriptive information about the portfolio, like portfolio beta, NAV, volatility, among other information. If the portfolio represents a linked brokerage account (like a brokerage account at Fidelity® or Etrade®), then this database table may include information on that brokerage account, like the account name and credential information.

Element 420 describes an example database table to hold position data. This data may include a portfolio ID to reference which portfolio holds the position, a security ID to reference the specified investment, a quantity to represent the size of the positions, and a cost or average price of the purchase, among other information.

Element 435 describes an example database table to hold trade data. This data includes information to describe a trade or financial transaction, and could include fields like a profile ID, a position ID, a security ID, a trade quantity, a trade cost or purchase price, a timestamp, among other information.

Element 425 describes an example database table to hold category data. The data includes information to describe a financial category or other aggregation of financial securities, and could include fields like category name, industry, description, among other information.

It will be understood that the data structures shown in FIG. 4 illustrate but one example and non-limiting implementation of the distribution of financial data, profile data (demographic data) and social data among various data structures and data elements. Any or all of these data structures and respective data elements may be combined, distributed, or otherwise reformatted to obtain other data structure formats.

### Presentation of User Data Among Socially Connected Users

FIG. 5 shows one example user interface that employs the data stored within the financial social network to share financial holdings among users. In particular, user interface 500 may display data provided by the server that shows the financial holdings of a given user's social contact. In this example, the interface allows a user to view the financial holdings 520 of their social contact (e.g. “friend”) “User 2” 510. The holdings may be organized into categories such as “High Dividend Paying Funds” 525, “Emerging Market Stocks” 540, “Technology Stock” 555, and may show the dollar amounts owned or a percentage of the portfolio that is owned in each of those specific categories. Holdings may be specified down to ticker or individual investment level, like examples 530, 535, 545, 550, 560, 565. These holdings may show the dollar amounts owned or a percentage of the portfolio that is owned in each of these specific holdings.

According to several example embodiments, the stored social and financial data of the financial social network may be employed to present, to a given user, information pertaining to the financial holdings and/or interests of a user's social contacts. Referring to the preceding example involving Users 1, 5 and 8, User 5 may own AAPL and GOOG stock. When User 1 logs into the social financial network using a client computing device presenting a user interface associated with the financial social network (such as a computer with a web browser), the user interface may be configured to show links to User 5 and User 8. If User 1 chooses to view User 5's financial profile (e.g. as shown in FIG. 5), the content will be provided to the user interface (e.g. a web server serving web page data) showing that User 5 has investments in AAPL and GOOG. Another similar view would show all the recent trades that social contacts of User 1 have executed (in this example, the trades executed by Users 5 and 8).

### Automated Generation of Descriptive Sentence or Phrase Summarizing User

As shown in FIG. 5, user interface 500 may include a computer-generated descriptive sentence or phrase 515 that summarizes an investor and their holdings. This generated sentence may contain summary information that is determined by processing the user's stored financial data to obtain one or more summary metrics such as, but not limited to, the user's risk tolerance, level of trading activity, and largest or most relevant investment categories as seen in their holdings. This summary sentence allows a given user to quickly obtain summary information associated with the holdings and/or investment activity of their social contacts.

In one example embodiment, the summary metrics for use in forming a descriptive sentence or phrase can be obtained by processing a user's financial activity data to identify one or more securities having associated therewith a number of trades exceeding a pre-selected threshold, or for example, by processing the user's financial holding data to identify one or more securities comprising a percentage of the portfolio's value that exceeds a pre-selected threshold, or for example, by processing the user's financial holding data to identify one or more categories comprising a percentage of the portfolio's value that exceeds a pre-selected threshold. A sentence may then be generated describing that the user is active in the securities or topic that meet or exceed the respective threshold.

The sentence can be generated, for example, based on pre-configured sentences or phrases, having variables that are determined by processing the user's financial data. An example of a generic sentence including user-based variables is as follows: “<USER>has <PERCENTAGE>of <GENDER>portfolio allocated to stocks <STOCKS>”, where <USER>, <PERCENTAGE>, <GENDER> and <STOCKS> are variables that are determined by processing the user's associated financial data (and optionally profile data, for example, to obtain the gender determination, as in the present example). For example, the processing of the financial holding data may result in the generation of the following descriptive sentence: “User 1 has 60% of his/her portfolio allocated to stocks XXX, YYY and ZZZ.”

The user interface may therefore provide, to a given user, a descriptive sentence for other users of the financial network who are social contacts with the given user. For example, FIG. 5 illustrates an example case where a descriptive sentence is provided to summarize User 2, who is a social contact of User 1.

In some example embodiments, these securities may be associated with a category that characterizes the type of security, for example, according to sector. For example, the three securities XXX, YYY and ZZZ in the aforementioned example may all be determined to be categorized as tech stocks. In such a case, these securities may be associated with a “tech” category array that is stored a securities database that forms a component of the financial network or is accessible to the financial network. A descriptive sentence or phrase may be then generated indicating that User 1 has a major investment in tech stocks, based on the association of the three stocks with the “tech” category.

A similar method can be implemented to process the user's financial data to calculate portfolio metrics, such as risk metrics to describe the risk appetite of the user. In one non-limiting example, a portfolio's beta can be calculated by determining the value weighted average of each of a user's holdings' covariance with a benchmark index such as the S&P 500. A descriptive sentence or phrase can be generated to describe the user's risk preference. In this case a high beta would result in a sentence describing the user as having a high risk appetite. In some embodiments, the descriptive sentence or phrase is dynamically updated when the user's associated beta value crosses a threshold value.

### Presentation of Financial Activity of Socially Connected Users

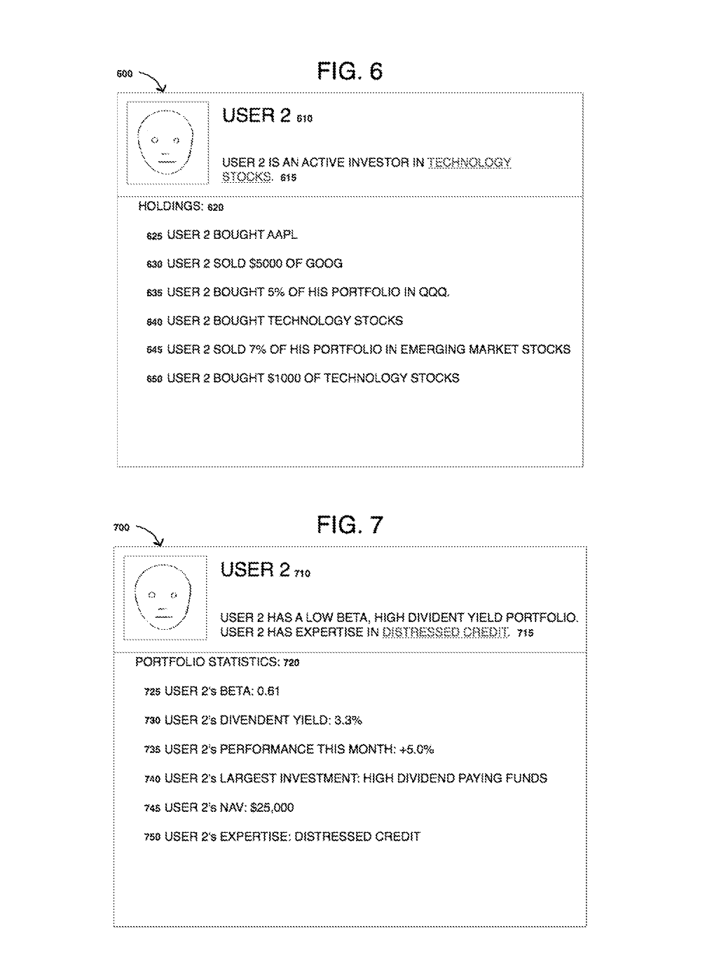

FIG. 6 shows one example interface that uses the present financial social network to share financial activity among socially connected users of the financial social network. In the example screenshot shown, user interface 600 may display data provided by the server that shows the trade activity of a given user's social contact. In this example, user interface 600 allows a given user to view the trades and investment activity of their social contact User 2 (610). This financial activity may include information such as the recent and past trades of User 2.

Non-limiting examples of financial activity include: User 2 buying/selling a specific investment 625; User 2 buying/selling a dollar amount of a specific investment 630; User 2 buying/selling a percentage of their portfolio in a specific investment 635; User 2 buying/selling a category 640; User 2 buying/selling a specific dollar amount of a category 645; User 2 buying/selling a percentage of their portfolio in a category 650. As noted above, user interface 600 may include a generated descriptive sentence 615 that describes the financial activity of User 2. This generated sentence may employ the user's holdings to calculate the user's recent trade activity, amount of trade activity, and relevant financial holdings to build a natural language sentence describing what the user, as described above with reference to FIG. 5.

### Presentation of Portfolio Statistics of Socially Connected Users

FIG. 7 shows one example of user interface that is configured to share portfolio statistics among socially connected users. In the example screenshot shown in FIG. 7, user interface 700 displays statistical measures computed based on the investment portfolio of a User 2, who is a social contact of User 1. In this example, user interface 700 allows User 1 to view various portfolio statistics associated with their social contact User 2 710. Portfolio statistics 720 may include statistical measures such as, but not limited to: portfolio beta 725, portfolio dividend yield 730, portfolio performance both in outright terms and relative to various financial indices over various time frames 735; the portfolio's largest investments 740; portfolio NAV (Net Asset Value) 745; a measure of the financial expertise of the user as determined by processing the investments in their portfolio 750. Interface 700 may include a generated descriptive sentence or phrase 715 that describes the investor's portfolio statistics. This generated sentence may use the user's holdings to calculate the portfolio's statistics such as beta, yield, NAV and performance to build a natural language sentence describing that user's portfolio statistics.

### Presentation of Information Pertaining to Individual Security

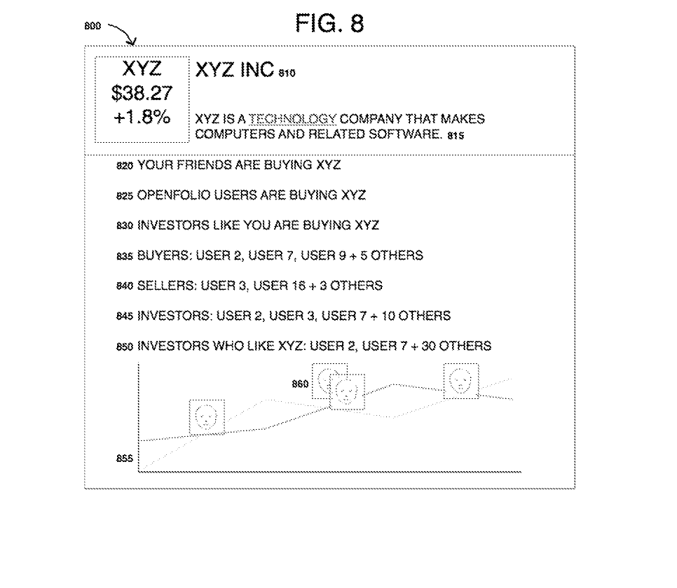

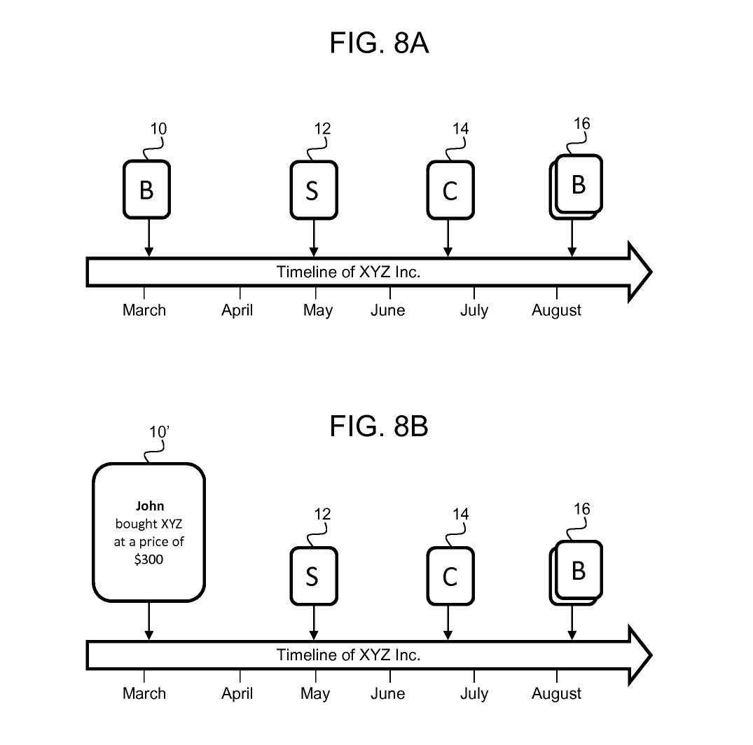

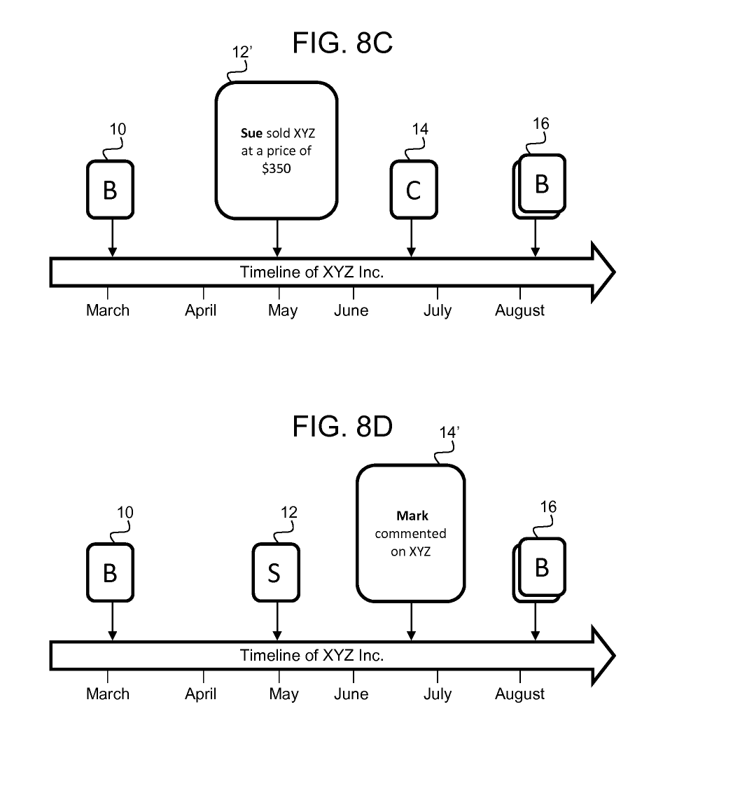

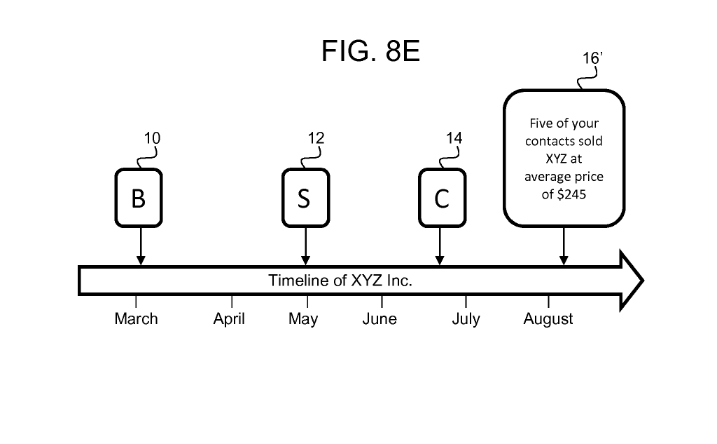

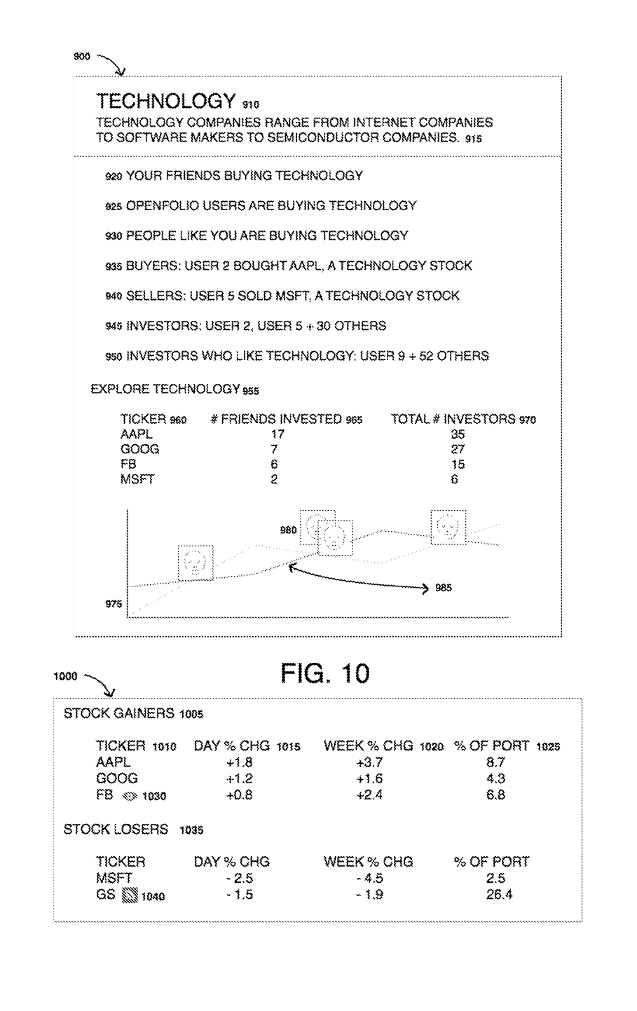

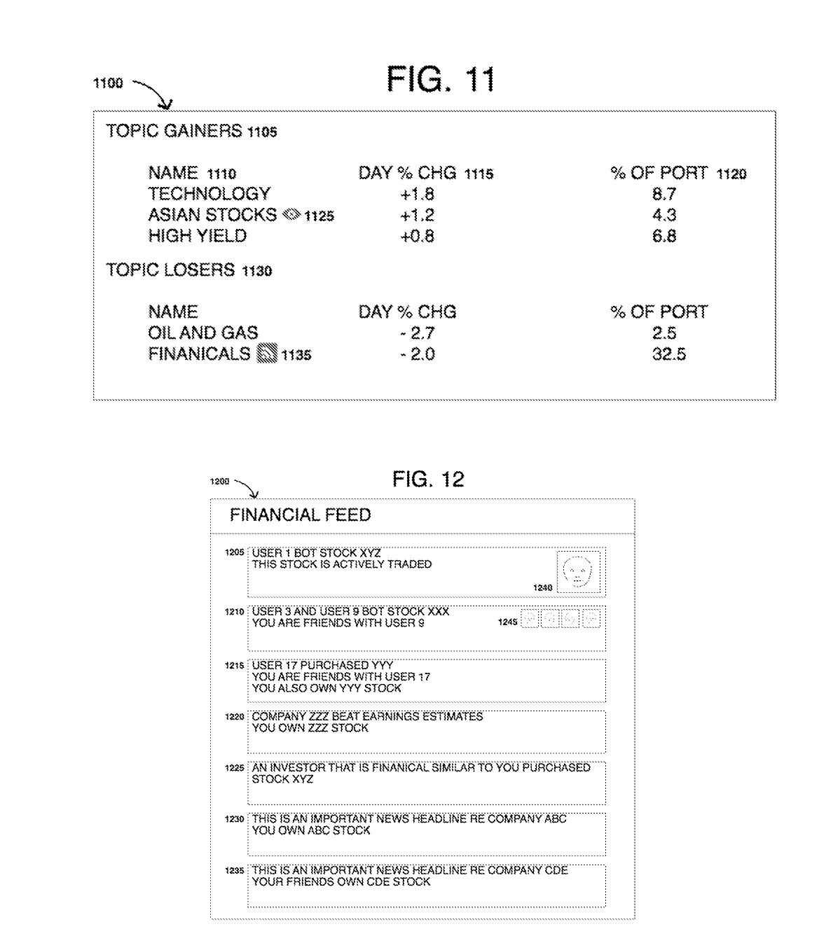

FIG. 8 shows an example user interface that uses the present financial social network to display news and activity with regard to a specific security (for example, after receiving input from a user selecting the specific security). For example, example user interface 800 display one or more of the user's social contacts who have traded, invested or are otherwise interested in a given security 810. The set of social contacts meeting this criteria may be obtained, for example, by querying a database storing financial transaction data associated with users of the financial social network, and to obtain a list of the user's social contacts have traded, invested, or are otherwise interested in a given security.

Example user interface 800 may include a description 815 of the specified security 810.

Example user interface 800 may provide a list, sentence or illustration describing which of the user's social contacts have bought 835 or sold 840 the specified security 810. This list, sentence or illustration may also include specific names or an aggregated number of other users, who are not social contacts or connected with the user, but who have also bought or sold the specified security.

Example user interface 800 may provide a list, sentence or illustration 845 describing which of the user's social contacts own a specified security. This list, sentence or illustration may also include specific names or an aggregated number of other users, who are not social contacts or connected with the user, but who also own the specified security.

Example user interface 800 may provide a list, sentence, illustration or other presentation format 850 describing which of the user's social contacts “like”, “follow”, are “interested in”, or “agree” with buying/selling/owning the specified security. This list, sentence or illustration may also include specific names or an aggregated number of other users, who are not social contacts or connected with the user, but who also “like”, “follow”, are “interested in”, or “agree” with buying/selling/owning the specified security.

Some of the information that is presented based on an identified security or category may be based on a trend analysis, as described in detail below.

The information that is presented to the user may be generated by the remote server by processing the financial data associated with the users of the financial social network. It will be understood that the information that is presented on example user interface 800 may alternatively be obtained by the computing device of the user, if the user's computing device has a direct connection a database storing the financial data, and can submit queries to the database to obtain the information to be presented.

### Presentation of Information Pertaining to Category

FIG. 9 shows another example user interface that employs the financial social network to present news and activity associated with a given financial category. As shown, example user interface 900 may be configured to show, for a given user, the user's social contacts who have traded, invested or are otherwise interested in a given category 910.

Example user interface 900 may provide a list, sentence, illustration, or other presentation format describing which of the user's social contacts have bought 935 or sold 940 securities within the category 910. This list, sentence or illustration may also include specific names or an aggregated number of other users, who are not social contacts or connected with the user, but who have also bought or sold securities in a given category. Example user interface 900 may also provide a list, sentence or illustration 945 describing which of the user's social contacts have invested or previously been investors in the given category or securities within the category.

In one example implementation, example user interface 900 may provide a list, sentence, illustration or other presentation format 950 identifying which of the user's social contacts “like”, “follow”, are “interested in”, or “agree” with buying/selling/owning the given category 910. This list, sentence or illustration may also include specific names or an aggregated number of other users, who are not social contacts or connected with the user, but who also “like”, “follow”, are “interested in”, or “agree” with buying/selling/owning the category.

The interface 900 may provide a list, table or illustration 955 that displays the individual investments associated with the given category. This element may show a list of tickers, names, or other identifiers for the specific investments 960, among other information like each security's performance, market capitalization, fund fees/ or expense ratio, and dividend yield. This element may also include the number of the user's social contacts who are invested/interested/follow/have traded each security 965 and may also include the total number of all users who are invested/interested/follow/have traded each security 970. In one example of how this element could be constructed, the element could be a table that orders the all the individual securities within the category by the number of the user's social contacts who are invested in each security. This table could be useful in displaying to the user the more popular individual investments of that user's social contacts within the specified category.

Performance Measures Associated with Single User

In another embodiment of the present disclosure, the financial social network is used to share and communicate investor performance information. Each user's financial performance can be calculated from their financial history. The performance could be calculated for the user's entire portfolio as a broad measure of overall portfolio performance, or the performance could be calculated for a specific category or other subset of the portfolio. Each user's financial performance within a given category can be calculated from their financial history within that category and a categorization system that categorizes individual securities into specific categories. Performance could be displayed as percentage return over a specified time period, or total dollar return over a specified time period.

More sophisticated methods of performance known to those skilled in the art could also be used. Some more sophisticated methods include risk-adjusted performance, information ratios, Calmar ratios, and Sharpe ratios, among others. The performance figures for a specified user may be displayed solely to that user or may be shared with social contacts of that user, social contacts of social contacts of that user, or the entire network. The network may include a “celebrity”, “share with everyone”, or “professional” mode where those users elect to share their performance information widely; alternatively, there may be a “private” or “do not share” mode where user's elect to hide their performance information from others.

The present system has been configured to provide many types of performance measures. In an example embodiment of the present disclosure, a user or group of users' performance information may be compared to an existing financial index, or a dynamically generated index that averages other user's performance information as found in the financial social network. The dynamically generated index may use a simple average to combine the individual performance information of the users, or may use more complicated average or summations known to those skilled in the art. The performance and index may be a broad measure of overall performance, or may be specific to a category or other portfolio subset.

### Identification of User Cohorts

In several example embodiments of the present disclosure, user cohorts may be identified and employed for a wide range of applications, including producing aggregate measures for comparison with a specific user and identifying trends among a subset of the user population. A user cohort is defined herein as a subset of the user population of a financial network (which may be a financial social network), where the subset of users shares one or more common attributes or characteristics. For example, a user cohort may be a subset of users that satisfies one or more criteria, such as the set of users who have an age between 25-30 years and have a portfolio having a relative investment in technology exceeding a threshold value.

In one example implementation, a user may submit a query to obtain aggregate financial measures based on a user cohort that determined based on user-provided criterion. This allows a user to obtain, an optionally compare themselves against, one or more aggregate financial measures that are obtained based on customized “slices” through the set of users. A user cohort, as determined based on one or more user-provided criteria, may be obtained to produce a cohort-based aggregate portfolio.

It will be understood that there are many different methods that can be employed to produce an aggregate portfolio, by processing the financial holdings of a user cohort. For example, according to one example embodiment, an aggregate portfolio may be obtained by.

It will be understood that there are many different methods that can be employed to produce an aggregate portfolio, by processing the financial holdings of a user cohort. For example, according to one example embodiment, an aggregate portfolio may be obtained by first selecting the portfolios for each user in the user cohort. The relative positions for each security in each user's portfolio could then be averaged to create an aggregate portfolio for the cohort. In one example of this method, if user 1 has a portfolio that is 30% AAPL and 70% GOOG, user 2 has a portfolio that is 20% AAPL, 20% GOOG and 60% GM, and user 3 has a portfolio that is 25% AAPL, 10% GOOG and 65% GM, the aggregate portfolio for the cohort that includes users 1, 2 and 3 would be 25% APPL, 33.3% GOOG, 41.6% FB. Another method of this aggregate portfolio construction may filter or otherwise exclude certain user portfolios from the aggregate portfolio construction using limiting criteria. For example, the user portfolios included in the aggregate portfolio may be selected to only include user portfolios that are within a certain portfolio return range. Another example of limiting criteria may exclude the best 10% and worst 10% performing portfolios from all user portfolios within the user cohort.

This average portfolio may be further synthesized or summarized into categories based on sector, industry, or other characteristics. In the example average aggregate portfolio example above, because AAPL and GOOG are “tech” stocks, and because GM is an “auto” stock, the average portfolio could be described as 58.3% “tech” and 41.6% “auto”. An alternative form of this summarization may only summarize positions below a certain position size threshold into categories. For example, consider an aggregate portfolio with positions of 1% AAPL, 1.5% GOOG, 2% FB, 2.5% YHOO and 93% GM. If a threshold value of 3% is selected, this portfolio could be summarized into an aggregate portfolio described at 7% “tech” and 93% GM, because AAPL, GOOG, FB and YHOO are all tech stocks with a total position size below 5%.

In another example embodiment, an aggregate portfolio for a user cohort could be created by first selecting all user portfolios in a user cohort and then summarizing or synthesizing each user portfolio into a lower dimensionality or categorized portfolio. Each of these lower dimensionality user portfolios could then be averaged or otherwise combined into a single aggregate portfolio for the cohort. For example, all user portfolios in a user cohort could be summarized into portfolios describing the sector weightings of each user. These sector weightings could then be averaged or otherwise combined into a single aggregate portfolio.

An aggregate portfolio may be employed to generate a user cohort index, which provides a clear and aggregate indication of the time-dependent performance of the user cohort. Such an index may be calculated by taking the positions in the aggregate portfolio and constructing a hypothetical portfolio with those positions. For example, if the aggregate portfolio has positions of 30% AAPL and 70% GM, the user cohort index could be created by calculating the hypothetical performance of this portfolio. If the aggregate portfolio is described using summary or category terms, such as a portfolio that is 30% “tech” and 70% “auto”, indices for the categories may be used to calculate the hypothetical performance. An aggregate portfolio may be employed to generate a user cohort index, which provides a clear and aggregate indication of the time-dependent performance of the user cohort.

The index may be employed for comparisons with the performance of a given user (e.g. comparing to a “user index” associated with the holdings of a given user), and/or other indexes, such as standard indexes, or indexes generated based on other user cohorts. A user cohort index may also be compared with a composite index formed from the aggregate holdings of all users in the financial network, or, as described below, compared with an aggregate similarity-based index generated based on the financial holdings of all of the social contacts of a given user.

In one example, a given user may be a 35 year old professional with $100k in savings. The user may compare his or her performance versus the broad performance all other users in the network, or the user may compare his or her performance versus the broad performance of all 30-40 year professionals with a savings between $50k-250k. As another example, the user may be an active investor in technology stocks. The user may compare his or her performance within the technology category versus a specific technology index, or the user may compare his performance versus an index of the technology investments of other 30-40 year old professionals who trade technology stocks more than 5 times a year as seen in the financial network.

### Correlation-based User Cohorts

A correlation-based user cohort is a type of user cohort that is defined with respect to (i.e. based on) given user, where each user of the correlation-based user cohort has a correlation (e.g. commonality, relationship, or association) with the given user of a financial network or financial social network. A correlation-based user cohort can be defined, for example, based on a financial correlation, a user profile (demographic) correlation, and/or a social connection.

Any of the preceding methods of generating an aggregate portfolio, and/or index, based on a user cohort, may be employed to generate an aggregate portfolio, and/or index, based on a correlation-based user cohort.

A simple example of a correlation-based user cohort that is defined by a user profile similarity is the set of users having the same gender of the given user. A more complex example of a correlation-based user cohort that is defined by a user profile correlation is the set of users having a postal code indicating a mailing address that is within 50 km of the given user, and having attended an academic institution that was attended by the given user.

An example of a correlation-based user cohort that is defined by a financial similarity is the set of users having a cash position, as a percentage of overall holdings, that is within a prescribed percentage range of the cash position of a given user. More complex measures of financial similarity may also be defined, as described further below.

It will be understood that a correlation-based user cohort may involve a correlation pertaining to any one or more of financial data, user profile data, and social data. An example of a correlation-based user cohort involving both a financial correlation and a user profile correlation is the set of users having a cash position that is within 10% of the cash position of a given user, and who have attended an academic institution in common with the given user.

In another embodiments, an anti-similarity user-based cohort may be obtained by selecting the subset of users that is not similar to the given user, as per a correlation that identifies similar users. For example, the anti-similarity user cohort associated with the previously described correlation-based cohort involving user-profile based similarity is the set of users having a postal code indicating a mailing address that is beyond (i.e. not within) 50 km of the mailing address of the given user, and not having attended an academic institution that was attended by the given user.

A correlation-based user cohort may be defined, at least in part, based on social connections between a given user and other users. For example, a correlation-based user cohort may include all users with whom the given user has a direct social connection. Another example of a correlation-based user cohort involving social connections is the subset of all users through which the user is directly socially connection, and indirectly socially connected through one direct social connection.

Additional criteria may be applied to filer a correlation-based user cohort, in order to obtain a subset of users that (a) satisfies one or more correlation-based criteria and (b) satisfies one or more additional selection criteria, where then one or more additional selection criteria are not based on similarity. For example, a filtered correlation-based user cohort may be obtained by filtering a correlation-based user cohort to obtain a further subset satisfying performance criteria, such as net return. An example of a filtered correlation-based user cohort is the set of social contacts of a given user that has a net return exceeding a pre-selected amount (or a pre-selected market index). Another example of a filtered correlation-based user cohort is the set of social contacts who have actively traded within the past month.

In several embodiments of the present disclosure, a correlation-based user cohort is identified based on the direct evaluation of one or more criteria, in the absence of selection based on ranking and scoring of the set of users. In a score-and-rank method, a score is computed for each user (including the given user), and the resulting scores are then employed to produce an ordered list of users according to score. The subset of users is then defined by those users having a score that is within a variance range to the score of the given user.

Such a method has the drawback that the selection of users based on score opaquely determines which users are selected to be members of the subset. For example, the system may select, based on pre-established threshold parameters, the set of users having a score that is within +−10% of the score of a given user. This method has the disadvantage of providing an opaque filter for the selection of the subset of users for inclusion in the correlation-based user cohort, because the selection of the users based on score is decoupled from the similarity criteria. Furthermore, some measures, such as geographical location, are not amenable to a scoring-based selection method.

In contrast, in several example embodiments provided herein, a user-cohort, and/or a correlation-based user cohort, may be defined based on the evaluation of criteria that clearly determines whether or not a user is to be included as a member of a subset of users. In such embodiments, the criteria is directly associated with the similarity measure, and is not obscured based on scoring, ranking, and selection. For example, in the case of a correlation-based user cohort involving geographic distance, the direct criterion may be “users with a mailing address within 20 km of the given user”, which will include, for a given user, only those users satisfying the direct criterion. This clear and direct criterion avoids the opaque nature of the inclusion criteria that is associated with a computed score.

The difference between using direct and specific inclusion criteria, as opposed to score-based inclusion criteria, can also be understood with multiple criteria are employed to select a subset of users. In one example, multiple inclusion criteria may include (a) financial similarity inclusion criteria based on the cash position of a given user and (b) demographic similarity involving the given user's age. In the case of direct inclusion criteria that is based on the similarity measures, the inclusion criteria may be: users that have (a) a cash position within +−10% of the given user's cash position and (b) an age within 10 years of the given user. This inclusion criteria is clear and unambiguous. However, using a scoring-based method for defining inclusion criteria, a net score will be obtained by computing scores for all users based on cash position and also scores for all users based on age, and then producing a composite score for each user according to some weighing criteria. After having generated the composite scores for all users, a subset of users is selected having a composite score that is within a prescribed range (e.g. +−10%) of the composite score of the given user. This selection criteria, as applied to the composite score, is opaque, and the given user will not know the meets and bounds that define the inclusion criteria as per the similarity measures that were selected. In other words, the given user will not know, or be able to directly control, the specific range of the cash positions that define the inclusion criteria, nor the specific range of ages that define the inclusion criteria.

It is noted, however, that in some example embodiments, scoring and ranking may be applied after having identified a user cohort (which may be a correlation-based user cohort), in order to enable the given user to evaluate how his or her performance rates relative to the users within user cohort. For example, after having identified a user-cohort, the users within the user cohort may be ranked according to net return, and the given user may be provided with information identifying his or her rank within the subset of users.

A correlation-based user cohort may also be defined by calculating a financial similarity measure between a given user and a set of other users, such that users for whom the calculated financial similarity measure exceeds a threshold value are deemed to be members of the correlation-based user cohort. Correlation-based user cohorts may also be determined based on a measure of social similarity, or combined social and financial similarity. Examples of methods of calculating a financial similarity measure, a social similarity measure, and a combined measure of financial and social similarity, are provided below.

Annotation of Time-Dependent Visualizations with User Event Information

In some example embodiments of the present disclosure, a time-dependent visualization of information associated a selected security may be provided on a user interface, where the time-dependent visualization is annotated with information associated with events involving users of the financial social network. As described in the example embodiments provided below, each annotation may be presented on the time-dependent visualization at a time point that corresponds to the annotated event.

FIG. 8 illustrates an example embodiment of a time-dependent visualization that includes annotations associated with user transactions. The figure shows price chart 855, which has been annotated with graphical annotations 860 that relate to various transactions made by users of the financial network. In an embodiment in which the financial network is a financial social network, annotations 860 may relate to transaction events associated with social contacts of a given user. The price chart of the selected security may be plotted based on historical price data that is obtained from a server or database forming a component of the financial network, or, for example, through an external data source such as Google Finance.

The annotations may relate to transaction events, such as the buying and/or selling of a security. The annotations may alternatively or additionally relate to non-transaction events, such as events associated with social media metadata provided by one or more users with respect to the selected security. The annotations on the time-dependent visualization could involve events relating to a user's social contacts commenting or otherwise providing input associated with the security or index. Non-limiting examples of social media metadata events for which annotations may be displayed on a time-dependent visualization include, for example, events involving like/dislike input, follows, agrees, tagging input, highlighting, blog postings and/or comments. The annotations may also relate to simulated trading events. The annotations could be filtered or limited by the degree of financial or social similarity the user has relative to the users who produced the annotations, as described below.

It will also be understood that such annotations may be provided with respect to time-dependent visualizations of categories. For example, the time-dependent visualization may pertain to an index. The index may be associated with a category, or for example, a financial sector or industry, or, for example, a user cohort. For example, FIG. 9 illustrates an example embodiment of a time-dependent visualization that includes annotations associated with user transactions involving an index associated with a selected category. The figure shows price chart 975 plotting data 985 pertaining to an index associated with the category, which has been annotated with graphical annotations 980 that relate to various transactions made by users of the financial network, where the transactions pertain to securities that are associated with the selected category. This index 985 could be generated based on a market capitalization weighted, price weighted, or use another index calculation method to form a price over time or other performance history for the specified category.

In an embodiment in which the financial network is a financial social network, annotations 980 may relate to transaction events associated with social contacts of a given user.

A wide range of time-dependent visualizations may be annotated according to the example methods described herein. For example, as shown in FIG. 8 and FIG. 9, the time-dependent visualization may be a two-dimensional price chart, plotting the price of a security as a function of time. In such a case, the annotations may be presented on the plotted data, as shown in FIG. 8. Alternatively, the annotations may be shown at a different location on the graph, at the relevant time points. For example, the annotations provided in a time-dependent price chart may be displayed at a location other than on the plotted data, such as at or near the time axis.

In another example implementation, the time-dependent visualization may be provided as a three-dimensional graph, such as a surface graph, where two quantities are plotted as a function of time.

In another example implementation, the time-dependent visualization may be provided as a one-dimensional plot in the form of a timeline.

The time-dependent visualizations are not to be restricted to time-dependent price data. For example, other forms of data that may be plotted include volume, or another measure of the security.

It will be understood that a time-dependent visualization may include more than a single security. In such a case the annotations may be provided for one or more of the displayed securities.

In one example implementation, the annotations may be associated only with social contacts of the user. Such a case is an example of the plotting of data associated with a correlation-based user cohort. Other examples of correlation-based user cohorts are described elsewhere in the present disclosure.

In one example implementation, the annotations may also or alternatively include annotations pertaining to events associated with user who are not social contacts of the given user. In the latter case, the annotations may be anonymized in order to conceal the identity of the other users who are not social contacts with the given user.

The set of users for which associated annotations are to be graphically displayed may be filtered according to one or more criteria, such that a given annotation is only displayed when the criteria is satisfied. An example of a filtering criterion is a threshold number of degrees of social connectivity relative to the active user (e.g. limiting the displayed annotations to those involving direct social contacts of the given user). Another example of a filtering criterion is a threshold associated with a performance metric measure, such as a minimum return. Another example of a filtering criterion is a time window during which transactions were executed (e.g. limiting the displayable annotations to events that took place during a time interval such as, but not limited to, the past week, month, or year. The filtering criteria may be provided by user input, such as a user selecting criteria from a set of selectable criteria that is displayed on a user interface.

Although the preceding example embodiments involving annotations have described annotations on a per-event basis, it will be understood that in some cases, two or more events may be represented by a single (aggregated) annotation. For example, two or more events may be represented by a single annotation when the events occur within a pre-selected time interval.

One or more of the annotations that are displayed on a time-dependent visualization may provide information that identifies a user, or could be employed to identify a user. For example, the annotation may include information such as, but not limited to, a textual user identifier, a user icon, a user avatar, and a user profile picture. For example, price chart 975 in FIG. 8 includes annotations 980 that display user icons or user profile pictures.

The set of users may also be filtered or selected such that annotations are only provided for a subset of users that belongs to a user cohort, or a correlation-based user cohort, as described above. For example, in one example implementation, annotations may only be displayed for users that are members associated with a correlation-based user cohort involving a demographic similarity, such as a similarity based on geographic proximity.

In some example embodiments, the annotations that are rendered on the user interface of the user are displayed irrespective of input provided by the user. In other example embodiments, however, the one or more annotations may only be rendered or displayed when user input is received at or near the temporal region of the time-dependent visualization that corresponds to the event associated with the annotation. In one example implementation, a given annotation, which is associated with a user event occurring at a given time, may only be displayed unless input is received at, near, or adjacent to the region of the time-dependent annotation that corresponds to the given time. In the absence of the input at the temporal region associated with the event, the annotation may be fully hidden, partially displayed (e.g. according to a pre-selected transparency level), or an alternative annotation may be presented.

In the latter case, the alternative annotation may be a generic annotation that indicates that a user event has occurred, without presenting user-identifying information associated with the event. For example, an alternative annotation may be a simple geometric shape such as a star, circle, or other shape. Upon the detection of user input at the temporal region associated with the event, the alternative annotation may be replaced by the user-specific annotation.

For example, in the case where the time-dependent visualization is a price chart of a selected security, a user event may involve a purchase of a selected security, where the purchase was made by a social contact of a given user, and where the purchase occurred on Sep. 24, 2015. The annotation may be hidden, partially displayed, or indicated by an alternative (e.g. generic) annotation, as noted above, in the absence of user input in the region of the price chart corresponding to, or adjacent to, the date of Sep. 24, 2015. If user input is received within this region, for example, in the form of mousing over the region, or touch input over the region, or a gesture over the region (if the user computing device is configured to detect spatially-resolved gestures), or the detection of eye gaze within the region, then the annotation is displayed. The region over which the input triggers the display of the annotation may depend on the form of the input provided. For example, in the case of touch input, the region may be a region having a size that is approximately 1-2 cm in width (e.g. a width that is approximately equal to the typical size of a fingertip). Those skilled in the art will be able to determine an appropriate region for other input mechanisms.

For example, referring to FIG. 8A, a one-dimensional timeline of security XYZ is shown annotated with annotations “B” (10), indicating a buy event associated with a social contact, “S” (12) indicating a sell event associated with a social contact, and “C” (14) indicating a comment event associated with a social contact. Annotation 16 indicates multiple buy events associated with several social contacts. In the absence of input from the user, the user interface is shown as in FIG. 8A. However, referring to FIG. 8B, if local user input is received on the user interface at or near annotation 10, then a new annotation 10′ is shown, providing more detail on the event. FIGS. 8C-E illustrate the detailed annotations 12′, 14′ and 16′ that are rendered when user input is received at or near locations 12, 14 and 16, respectively.

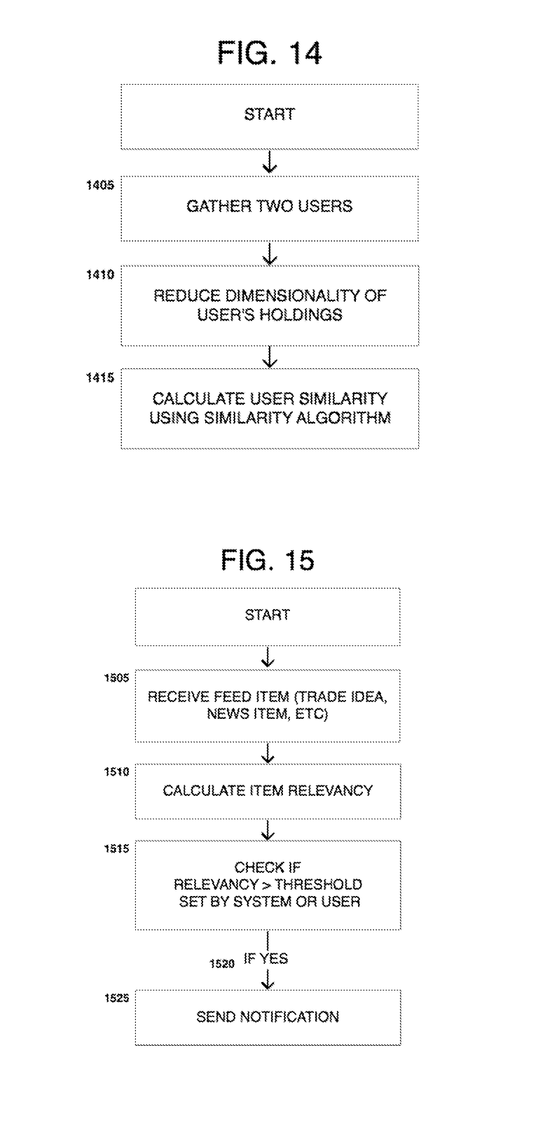

Referring now to FIG. 14, a method is provided for annotating a time-dependent visualization associated with a financial security, where the annotation is based on transaction events associated with users of a financial social network. In step 1800, input is received, from a user, identifying a selected security to be displayed. The input could be received directly via a computing device operated by the user, or received in the form of a message or data that is transmitted to a server via the user's computing device, for remote processing. User transaction data is then accessed that contains data elements correlating past transactions (e.g. buy and sell executions) with users of the financial network, as shown at 1805. This user transaction data could be stored locally within the user's computing device or within internal or external memory associated with a remote server, or, for example, accessed from a separate database.

The user transaction data is processed, in step 1810, to identify a set of matching transactions that involve the selected security, and to identify a matching user associated with each matching transaction, thereby identifying the user transaction events associated with the selected security. This can be achieved, for example, my making suitable database queries in order to extract this subset of information.

Having identified the set of matching transactions (and matching users) associated with the selected security, an annotated time-dependent visualization of the selected security is then generated, with annotations pertaining to the user transaction events. In some cases, in which the processing of the user transaction data is performed on the user's computing device, the annotated time-dependent visualization may be rendered directly on a user interface associated with the user's computing device. In other embodiments, in which the processing of the user transaction data, and the identification of the matching events, is performed remotely, the annotated time-dependent visualization may be prepared in a format that can be transmitted the user's computing device for subsequent rendering thereon. For example, the annotated time-dependent visualization can be prepared is a digital image, or, for example, as computer-readable instructions for generating a digital image.

### Intra-User Trend Analysis and Presentation

In some embodiments, one or more aggregate trends may be computed by processing financial data associated with one or more users, and presented to a given user. For example, remote server may process the financial data associated with the one user of a financial network, or a financial social network, in order to identify one or more trends associated therewith. Such a trend is henceforth referred to as an intra-user trend. Such trend analysis may be useful in helping an investor to identify his or her own trends or behavioural patterns, and/or trends or behavioural patterns associated with other users.

### Inter-User Trend Analysis and Presentation

In some example embodiments, trend analysis is performed based on events associated with two or more users. Such trends are henceforth referred to as inter-user trends.

An inter-user trend may be identified based on the processing of transaction data of a user cohort, in order to identify trends or behavioral patterns associated with a subset of users.

In one example implementation, referring to FIG. 8, user interface 800 may provide a list, sentence or illustration 825 describing a global trend in the aggregate activity of the entire social network for a specified security. As a simple example, the global trend “Users are buying security XYZ” could be calculated if more users in the financial social network are buying security XYZ then selling security XYZ. More sophisticated methods for generating trends could also be used.

Similarly, referring to FIG. 9, user interface 900 may provide a list, sentence or illustration 925 describing a global trend in the aggregate activity of the entire financial network for the specified category. As a simple example, the global trend “Users are buying category ABC” could be calculated if more users in the financial social network are buying securities within the given category then selling securities within the given category. Example user interface 900 may also provide a list, sentence or illustration 930 describing a trend in the aggregate activity of users who are members of a correlation-based cohort (e.g. a correlation-based user cohort involving a financial correlation), as described further below.

In one example embodiment, an inter-user trend may be identified based on the processing of transaction data of a correlation-based user cohort, in order to identify trends or behavioral patterns associated with a subset of users having at least one correlation-based correlation with a given user (such as, but not limited to, a financial similarity). In one example, trend analysis may be performed to identify one or more inter-user trends among the set of users who share a social connection with a given user, as described in the following section.

An example of an inter-user trend, based on the processing of financial transactions associated with various user cohorts, is the determination that a cohort involving 25-30 year old tech investors has increased their holdings in technology stocks over the past month. This can be communicated as “25-30 year old tech investors are increasing their tech exposure this month”. In this example, user profile data about users such as age and demographic is requested by the server upon registration and stored on the database. It is noted that trend analysis is not limited to the processing of trading activity; trends could be calculated from social medial metadata (e.g. opinion data) such as, but not limited to, “likes”, “follows”, “agrees”, comments, and/or other data sources.

### Inter-User Trend Analysis and Presentation to Identify Trends Among Socially Connected Users

As noted above, in some embodiments, an inter-user trend that is associated with social contacts of a give user may be identified, for example, by processing the transaction data (e.g. trade activity) of all social contacts of a given user, in order to one or more securities or categories for which two or more social contacts have an associated event during a prescribed time interval. In one example embodiment, the event may be a transaction event, such as the purchase of a security and/or the sale of a security. It is noted that such trends are user-specific, because they depend on the social connections of a given user, which will vary user to user. This can be contrasted with aforementioned methods of trend analysis, in which trends are identified based on global patterns without consideration to social connections.

Accordingly, in one example embodiment, the processing of the trade activity to identify one or more trends may involve processing financial data associated with the social contacts of a given user, in order to identify at least one security that two or more social contacts have purchased and/or sold during a prescribed time interval. One or more trends may additionally or alternatively be identified by processing metadata associated with the social contacts of a given user, in order to identify securities for which two or more social contacts have provided metadata during a prescribed time interval. Non-limiting examples of user metadata may include, for example, like/dislike input, follows, agrees, tagging input, highlighting, annotations, blog postings, and/or comments. The one or more securities that are identified may be displayed to the user, with information describing the trend associated therewith, for example, as a notification, alert, or feed item.

For example, a user interface may provide a list, sentence or illustration describing a trend in the aggregate activity of the user's social contacts. As a simple example, the trend “Your social contacts are buying security XYZ” could be identified and presented if more of the user's social contacts are buying security XYZ within a prescribed time duration. In another example, a user interface may provide a list, sentence or illustration describing a trend in the aggregate activity of the user's social contacts. As a simple example, the trend “Your social contacts are buying securities within category ABC” could be identified and presented if more of the user's social contacts are buying securities within category ABC within a prescribed time duration.

In another example embodiment, the processing of the trade activity to identify one or more trends may involve processing financial data associated with the social contacts of a given user, in order to identify at least one category that is associated with transactions made by two or more social contacts during a prescribed time interval. One or more trends may additionally or alternatively be identified by processing metadata associated with the social contacts of a given user, in order to identify at least one category for which two or more social contacts have provided user metadata during a prescribed time interval. The one or more securities that are identified may be displayed to the user, for example, as a notification, alert, or feed item.

The identification of a trend may be based on one or more threshold criteria. In the example embodiments provided above, a threshold associated with the identification of a trend may involve a minimum number of events (transaction events and/or user metadata events) within the prescribed time interval. In another example, a threshold criterion may involve the relative buy/sell, or like/dislike, event activity among social contacts of a given user, as per a given security or category.

For example, the trend “Your social contacts are buying security XYZ” could be displayed to a user if the number of social contacts of a given user who have bought security XYZ during a prescribed time interval exceeds the number of social contacts who have sold security XYZ during the prescribed time interval. Alternatively, the trend the trend “Your social contacts are buying category AAA” could be displayed to a user if the number of social contacts of a given user who have bought securities belonging to category ABC during a prescribed time interval exceeds the number of social contacts who have sold securities bellowing to category ABC during the prescribed time interval.

The preceding examples illustrated the identification of trends based on events associated with social contacts of a given user. In another example, trends may be identified by identifying at least one security that is held by two or more social contacts of the user, and processing one or more time-dependent measures (e.g. price, volume) of the identified security over a prescribed time duration in order to detect the presence of a trend. For example, a trend may be detected by a percentage change in the value of a security over a given day that is greater than an upper threshold or less than a lower threshold. Such a trend would allow a user to be presented with trends that are relevant to securities that are popular among the user's set of social connections.

### Generation and Presentation of Feed Items to a User

According to various aspects of the present disclosure, a user interface may be configured to display one or more feed items that are relevant to a given user, within a feed that is displayable on a user interface. As used herein, the term “feed” includes a set, list or other combination of feed items that is dynamically updated. The terms “feed item”, “feed element” and variants thereof refers to content that is discretely presented (e.g. posted) in a user interface, such that multiple feed items are discernable to the user as being presented separately. A feed item can include various types of data including character-based data, audio data, image data and/or video data. An information feed can be displayed in a graphical user interface (GUI) on a user's computing device, such as the display of a computing device.

The feed items may involve, for example, news events, transaction events, involving securities of the users of the financial system, and the relevance criteria may be based on a correlation between the users having made the transactions, and/or user metadata (comments, social media annotations, etc.) provided by users of the financial system. User metadata (comments, etc.) may be provided by users that are socially connected to a given user. User metadata may be provided by users that are associated with a correlation-based user cohort. Feed items that are user comments may related to any previous feed item.

At least some of the feed items that are presented to a given user satisfy one or more relevance criteria associated with the given user. The relevance criteria may be preconfigured. Alternatively, one or more relevance criteria may be user-configurable.

Feed items that are user-relevant may be dynamically generated by a feed generation engine, which is implemented by computer hardware to perform the methods described herein. Referring to FIG. ###, the feed generation engine dynamically processes input from one or more sources in order to generate relevant feed items for each user of the financial system. The feed generation engine may generate relevant feed items according to a number of different example methods. The feed generation engine may be employed to summarize, curate, synthesize or otherwise organize financial activity and information into a more useful feed.

In one example method, feed items are dynamically generated. For example, when a new event occurs, such as a new transaction, social media annotation, or news item, the new event is processed on a per-user level (e.g. sequentially, for each user), in order to determine if the event satisfies the relevance criteria, for the generation of one or more user-specific feed items. For each new event (e.g. each new transaction, each new social media annotation, and each new external news item), the relevance criteria associated with each user is evaluated, and a feed item is automatically generated for each user when the relevance criteria is met. Multiple relevance criteria may be evaluated for each user.

In another example of a method for dynamically generating user-relevant feed items, the system may access recent event data (e.g. obtaining recent events recorded in a database that were recorded within a pre-selected time frame) and process the recent events, on a per-user basis, according to the relevance criteria. This method may be performed at a fixed update rate. Alternatively, this method may be repeated after all users have been processed.

Feed items may also be dynamically generated based on trend analysis. In such a case, the relevance criteria associated with a given user may be pre-selected to identify one or more trends that may be automatically detected. For example, the relevance criteria may specify that financial event data, metadata event data, and/or news event data is to be assessed, for one or more (or all) securities owned by the given user, at a prescribed update interval. If the performance criteria specifies that financial trends are to be assessed (e.g. detected) for a given security held by a given user, then the financial transaction data associated with the given security, over a prescribed time interval (which may be different than the update interval), is processed in order to determine whether or not a trend exists. For example, a trend may be detected by processing the transactions involving the given security over the preceding week, and determining that the number of social contacts of the given user who had bought and/or sold the given security exceeded a pre-selected threshold. A feed item may then be automatically generated for the given user, identifying the trend.

Accordingly, in one example embodiment, the relevance criteria may involve holdings of a given user, such as securities that are owned by the given user. A feed item may be generated, for example, based on any one of the following example cases, according to various relevance criteria:
a) a transaction involving the security is detected as having been made by a social contact of the given user;
b) transactions involving the security are detected as having been made by one or more social contacts of the given user, where the number of transactions made by the social contacts exceeds a threshold number of transactions;
c) transactions involving the security are detected as having been made by one or more members of a correlation-based user cohort of the given user, where the number of transactions made by the members of the correlation-based user cohort exceeds a threshold number of transactions;
d) a trend involving the security is detected (several different examples of trends are provided above); and
e) a news item, report, or other external content associated with the security is detected (e.g. by an alert service associated with web-based content that is publically available).

The generation of feed items may additionally or alternatively be triggered by a transaction that is associated with another user, where a measure of financial similarity and/or social similarity exceeds a threshold. Example methods of calculating financial and social similarity among users are provided below.

Non-limiting examples events that may trigger the generation of a feed item (according to relevance criteria include transaction events (e.g. in real-time or near real-time) and information events, such as trade activity, ownership activity, financial news activity, earnings report activity, company headlines, economic data releases. Trade and ownership activity may reflect the activity of the user, or may reflect the activity of the social contacts of the user, the social contacts of social contacts of the user, “celebrity” or other well-known users, users that belong to a correlation-based cohort associated with a given user. For example, users that belong to a correlation-based user cohort may include users are financially similar a given user or users that share similar interests (or other demographic or user profile characteristics or attributes) with the given user. Feed item generation may also be triggered by other events, such as trade suggestions by users of the financial network and the posting or annotating of social media metadata, such as like/dislike input, follows, agrees, tagging input, highlighting, annotations, blog postings, and/or comments.

FIG. 12 shows an example user interface that presents an example feed of financial activity and information to a given user. Example user interface 1200 may be provided such that to show one or more feed items that are customized to a given user. Example user interface 1200 represents a display page showing seven news items relevant to the user. However, more or fewer than seven news items may be displayed.

As illustrated in the example feed shown in FIG. 12, one or more feed items may include a relevance indication, which provides an indication of the relevance of the feed item to the given user. For example, if a feed item is generated due to activity that was detected for a security that is owned by the given user, the relevance indication may indicate this ownership status, as shown, for example, at 1220.

Similarly, in another example, if a feed item is generated due to activity that was detected for a security that is owned by the social contacts of the given user, the relevance indication may indicate ownership status of the social contacts, as shown, for example, at 1210, 1215, and 1235. The social connection may be displayed, for example, as a list, sentence, illustration, or table. For example, in FIG. 12, displays the social contacts as a profile picture 1240 on the feed item. In another example embodiment, the social contacts are displayed as a list of profile pictures 1245 representing multiple social contacts.

FIG. 12 illustrates several non-limiting examples of feed items, including items 1205, 1210, 1215 that show the recent trade activity of the user's social contacts. The feed items may include anecdotal activity, such as the popularity of the trade, as shown at 1205; the social relationships with users who performed a transaction 1210; and information reporting whether or not user also owns, has previously owned, or has traded the security that the feed item references 1215.

Furthermore, example feed item 1220 displays a corporate action, such as an earnings release, along with a relevance indication identifying whether the user has an investment or financial interest in the referenced company or security. It is noted that item 1220 could additionally or alternatively display additional relevance indications, such as whether the user has social contacts with an investment or financial interest in the referenced company or security.

Example feed item 1225 displays the trade activity of a user who is “financially similar” to the given user, where financial similarity is defined below. Alternatively, trade activity may be displayed for a user who belongs to correlation-based user cohort that is based on a financial correlation with the given user.

Example feed items 1230 and 1235 display headlines showing company or corporate news, economic data, or other financial news that is relevant to the given user. As noted above, the feed item may also display one or more relevancy indicators, such as whether the given user has an investment or financial interest in the referenced company or news story 1230, or whether the user has social contacts with an investment or financial interest in the referenced company or security 1235.

It will be understood that a relevance indication associated with a feed item may be provided in the form text, such as a computer generated sentence or phrase, as shown in the example feed items presented in FIG. 12. However, the relevance indications are not limited to textual annotations, and may take many other forms. For example, a relevance indication may take the form of a different colour of the feed item, indicating a type of relevance. For example, feed items relating to securities or categories associated with the holdings of the given user may be provided in green, while feed items relating to securities or categories associated with the holdings of the social contacts of the given user may be provided in blue. Many other forms of relevance indications may be employed, such as the use of icons or different types and/or sizes of fonts.

### Prioritization of Display of Feed Items

In some embodiments, feed items are ranked according to the time at which they are generated, such that the most recent feed items are presented at the top of the list of feed items.

In other embodiments, the ordering of one or more feed items in the feed may be customized or prioritized according to a given user. For example, as shown in FIG. 12, ranking engine 1250 may be employed to sort, order, rank, the feed items within the feed.

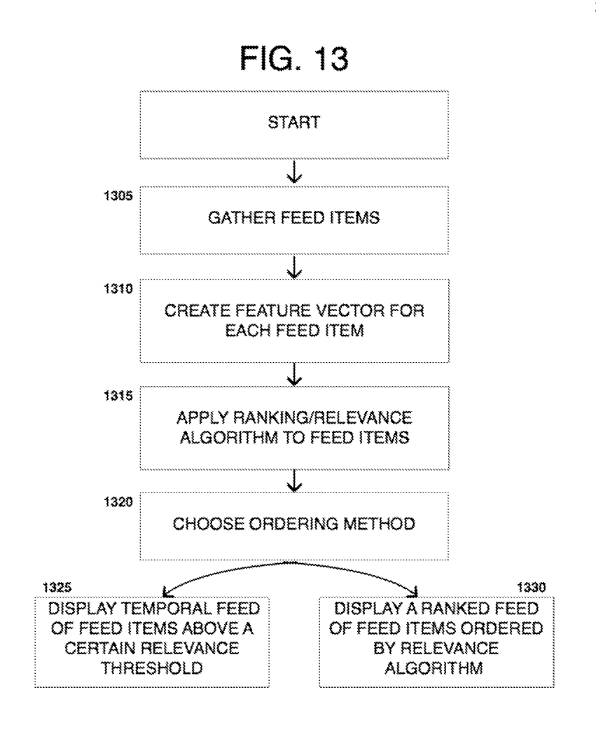

FIG. 13 is a flow chart illustrating an example and non-limiting method of ranking, ordering, or prioritizing the display feed items within a feed. This example method is illustrates the logical instructions that are executed by ranking engine 1250 (see FIG. 12).

At step 1305, the ranking engine may obtain, gather, collect or otherwise receive a set of two or more feed items. These feed items may be generic and global in nature or they may be personalized for a specific user according to relevancy, as described above.

At step 1310, the ranking engine processes the content associated with each feed item and generates a feature vector for each feed item. The feature vector is an n-dimensional vector of numerical features that are employed to represent the feed item, and to rank the feed item relative to other feed items.

An example method of ranking a feed, based on the generation of a feed vector, is described as follows. According to the present example, a feed is presented to User 1 in the user interface running on a computing device associated with User 1.

The event that triggered the feed item involved the recent purchase of a security XYZ by User 3, who is socially connected with User 1. The feed item “User 3 bought stock XYZ” is therefore generated by the feed generation engine (as described above), and this feed item is obtained for processing, and ranking, by the ranking engine (as shown in step 1305 of FIG. 13).

As noted above, the ranking engine generates a feature vector for this feed item. A first feature involves the query: “does User 1 own security XYZ”, which has a value of 1 if User 1 owns security XYZ and 0 if User 1 does not own security XYZ. Therefore, a first element of the feature vector has been defined, and the value is determined by processing the financial holdings of User 1. As can be seen by the present example, at least one feature of the feature vector is dependent on the given user, such that the relevancy ranking is personalized to the given user.

Another feature that may be employed to construct the feature vector is a measure of the “financial similarity” between User 1 and User 3. Examples of financial similarity calculations are described below, and in the “Financial Similarity Example” section of the present disclosure. For example, if the financial similarity score, as calculated, for example, in the “Financial Similarity Example” section of the present disclosure, is above a threshold, that feature could have a value of 1, otherwise zero.

In one example implementation, one or more features of the feature vector may be based on social connections between the user and other users. For example, a social connection based feature could take the form of “how many of User 1's social contacts own XYZ” and have the value n for the n social contacts of User 1 that own stock XYZ. In some embodiments, a measure of social similarity between a given user and another user employed as a feature. Such social connection based features may be employed to sort feed items, at least in part, according to social similarity between one user and at least one other user.

In one example implementation, at least two feed items may be ranked based on the social similarity between a given user and at least one user from the plurality of other users who has had one of the at least two feed items displayed to them. In another example implementation, at least two feed items may be ranked based on the financial similarity between a given user and at least one user from the plurality of other users who has had one of the at least two feed items displayed to them.

The number of features in the feature vector can be large and can change and grow over time. It is noted that many, but not necessarily all, of the features within the feature vector are informed, deduced or derived by the financial social network.

The example feed vector therefore involves two components: a first feature vector component identifying whether or not User 1 owns the security XYZ, and a second feature vector component defined by the financial similarity between User 1 and User 3. The components of the feed vector may be normalized (e.g. to unity) in order to facilitate the generation of a composite relevance score, as described below.

At step 1315 the feed items are ranked according to their respective feature vectors. In one example implementation, an example scoring protocol employs heuristics or rules to establish a relevance score for each feed item based on the feature vector associated with the feed item.

An example method for generating a ranking for a given feature vector involves obtaining the inner product of the feature vector with a reference vector having weighting coefficients as components. For example, if the feature vector is computed to be [1, 0, 4], then the inner product may be computed with the reference vector [0.2, 1, 0.5] to obtain a value of 0.5 for the score.

For example, in the example provided above, If User 1 owns security XYZ and is highly similar to User 3 (e.g. the similarity measure, normalized to unity, is 0.8), then the score for the feature vector is (1+0.8)/2=0.9. If several other feed items were evaluated to have scores of 0.6, 0.95, and 0.2, then the feed item having the score of 0.9 would be ranked second highest on the list, and displayed below the feed item having the score of 0.95.

Other non-limiting methods for calculating a score from a feature vector include: (i) calculating an inner product of the feature vector with itself; (ii) calculating the square root of the inner product of the feature vector with itself, thereby obtaining a measure of “length” of the feature vector, and (iii) performing (i) or (ii) while employing weighting coefficients to scale the components of the feature vector. In yet another example, a score for a given feature vector can be obtained by summing the components of the feature vector, and dividing by the dimensionality of the feature vector.

It will be understood that other measures, such as the magnitude of the feature vector, may be employed (such an embodiment would effectively apply a higher weighting to feature vectors of higher dimensionality).

It will be understood that other ranking systems may be used to rank the feed items, using feature vectors, or using other methods for assigning numerical relevance measures to feed items. Examples of other ranking algorithms include, but are not limited, to Ranking Support Vector Machines (SVM), Multiple Additive Regression Trees (MART), RankNet, RankBoost, AdaRank, as well as any other pointwise, listwise, or pairwise ranking algorithms known to those skilled in the art. These ranking algorithms can be used to produce a numerical score for each feed item or can be used to rank or sort the relative ordering of a list of feed items.

Referring again to FIG. 13, at step 1320 a method for ordering the feed items is chosen. Some methods may involve employing a relevancy threshold in order to prioritize one or more high relevancy score feed items over other feed items. Example ordering methods include, but are not limited to, temporal orderings and “top items” or relevance ranked orderings.

According to one example implementation, if a temporal ordering method is employed (for example as shown at 1325), items above a threshold relevance score as calculated by the ranking engine are displayed in order of time. Items below the threshold are hidden from the user's view. In some embodiments, the time stamp of a feed item may be compared to the present time to determine an age of the feed item, and the feed item may be removed from display (or archived) when the age exceeds a pre-selected threshold age. In another example implementation, items having a relevancy score above a pre-selected threshold score are displayed based on their relevancy score at the top of the feed, and items having a relevancy score below the pre-selected threshold score are displayed temporally below the high-relevancy feed items. It will be understood that other methods may be employed to provide mixed score/relevancy display of feed items.

In some embodiments, the time at which a given feed is generated may impact its score. For example, one feature (e.g. one component of a feature vector) of a feed item may involve a measure of the time duration that has elapsed since the feed item was generated or posted, such that more recent feed items have a higher feature score. This example embodiment, and variations thereof, would produce a ranking of feed items that depends on both time and relevance.

Another example of a ranking method is a “top ideas”, “top items” or similar method that ranks items by relevance. If such a method is employed, for example, as shown at step 1330, items are ranked and ordered by the ranking engine. The highest scoring or most relevant items may be shown at the top of the feed, thereby ranking, ordering and curating the feed. If the items in the feed mainly reflect trade activity, this feed may be called a feed of “top investment ideas” or “top trade ideas”, among other names. If the items in the feed mainly reflect news or headlines, this feed may be called a feed of “top news” or “top headlines”, among other names.

### Automated Generation of Investment Recommendations

In another example embodiment of the present disclosure, the financial social network and the ranking engine are used to generate investment recommendations or ideas. Given the financial social network dataset, the database comprises trades from all users of the financial social network. This data, and other data of the financial social network can be employed to train and improve the ranking calculations in the ranking engine, for example, using user input to provide feedback on the ranking results, and employing this feedback to improve the ranking algorithms. The ranking engine can then be used to rank all trade or investment activity and, for a specified user, provide a personalized and ranked list of the top investment ideas or trades for that user.

Methods of Calculating Financial Similarity and Other Measures of Similarity among Users

In one example embodiment of the present disclosure, a measure of “financial similarity” may be calculated between two or more users of a financial network (the financial network may be a financial social network). Unlike known methods of ranking users according to demographic or financial scores, the present example embodiments provide a measure of the financial similarity between two users, so that one user can evaluate the degree of similarity between himself or herself and another user of the financial network.

FIG. 14 is a flow chart illustrating an example and non-limiting method 1400 for calculating financial similarity between two users of a financial network.

At step 1405, two users are identified for the financial similarity calculation, and financial data of the two users is accessed or otherwise obtained.

In one example method, as shown at step 1410, the calculation of financial similarity may be based on financial attributes involving the holdings of the users, and the dimensionality of each user's financial holding may be reduced to facilitate the calculation of financial similarity.

According to one method of reducing financial holdings for dimensionality reduction, financial instruments may be grouped and categorized by category (e.g. sector, industry, or another classification). For example, a user may own many technology stocks in their portfolio, such as GOOG, AAPL and FB. When the dimensionality of that user's holdings is reduced, the user's many holdings in individual technology stocks are combined into a single technology category, thereby reducing the dimensionality of the portfolio to a category basis. Because each user's portfolio dimensionality is reduced in a similar way, comparisons between similar, yet dissimilar portfolios may be possible.

As another example, consider two users, User 1 and User 2, who each have portfolios consisting of many technology stocks but with no overlap in the specific technology stocks they own. If individual holdings of these investors are compared, User 1 and User 2 would appear to have no financial similarity. In mathematical terms, the projection of the holdings of these users onto a security basis set results in orthogonal vectors for the holdings of the two users.

However, if the dimensionality of both portfolios is reduced via projection onto a category basis, then the holdings of the two users are expressed on a set of common basis vectors, allowing a similarity measure to be obtained according to a mathematical operation. For example, if the categories are represented as basis vectors, and the holdings of each investor are represented as a vector in the category space defined by the basis vectors, then a measure of financial similarity may be obtained using cosine similarity, for example, by calculating an inner product of the category-space vectors of the two users.

At step 1415, the financial similarity between the users is calculated, for example, using the inner product method described above. As an example, each user's reduced dimensionality portfolio may be expressed as an n-element vector in category space, where each element represents that user's percentage holdings in that category, (e.g. for all n categories, or for a pre-selected subset of categories). For example, User 1 may have holdings of 30% tech, 20% energy, and 50% financials. User 1's holdings vector could be expressed as (0.3, 0.2, 0.5) in the category basis. User 2 may have holdings of 80% tech, 10% energy, and 10% financials. User 2's holdings vector could be expressed as (0.8, 0.1, 0.1). Cosine similarity measures the cosine angle between two holdings vectors of an inner product space and returns a number between 0 and 1. The cosine similarity of these two example vectors can be used as a measure the financial similarity between the users.

It will be understood that the presently described inner vector product method is but one example method of calculating financial similarity, and that other methods may alternatively or additionally be employed that involve a multi-element representation of financial attributes of the users, such as a calculation employing Jacaard similarity, Euclidean distance or any other algorithm or calculation known to those skilled in the art. The resultant score becomes a measure of financial similarity between the users.

It will be understood that the measure of financial similarity need not involve attributes based solely on the category of holdings, and that other attributes may be employed when calculating a similarity measure. For example, a similarity calculation may involve, in addition the category-basis of the holdings of the two users, attributes including other financial parameters, such as, but not limited to, cash position, one or more attributes associated with investment experience, one or more attributes associated with financial performance, one or more attributes associated with trading frequency, and one or more attributes associated with risk tolerance or exposure or volatility, to name but a few. For example, if trade frequency of a commonly held security is employed as an attribute when calculating financial similarity, then the financial similarity among two users may increase when one or both of the users trades a commonly held security.

In some embodiments, a particular security may be present in more than one list of categories and therefore a coefficient can be attributed to each component of the vectors generated on the server in order to represent the varying degree of importance between categories. For example, a particular stock can be represented by its identity category, a category that only comprises that particular stock. That stock can also be stored in a variety of other categories, however the component in the financial vector representing the identity category will, in general, receive the largest coefficient to represent the fact that two users with identical holdings will generally have a higher value of financial similarity than that of two users who both hold stocks in the “tech sector.”

It is also noted that measures of financial similarity are not limited to calculations between one user and another user. For example, a measure of financial similarity may be obtained based on a calculation among an actual user and a fictitious user, or a fictitious portfolio. In one example implementation, a financial similarity value can be calculated between a user and a category. In this case the server can create a fictional user with a fictional portfolio comprising equal or weighted securities comprised in the category list. The server will then determine a financial similarity score between the user and the fictional user representing the category.

A financial similarity value can be calculated between a user and a feed item. The feed item can be represented by a fictional user with a fictional portfolio comprising equal or weighted securities comprised in one or both of the feed item author's portfolio or the list of securities mentioned in the news feed item.

The aforementioned methods of calculating financial similarity may be adapted to include additional attributes when calculating similarity. For example, in one embodiment, one or more demographic attributes may be employed, such that that similarity measure between two users is a combined measure of both financial and demographic similarity.

The aforementioned methods of calculating financial similarity may alternatively be adapted to include social attributes when calculating similarity. The social similarity may be defined as the number of degrees of separation between the pair, or with any other calculation known to those skilled in the art. Non-limiting examples of how social similarity can be calculated are described in the “Social Similarity Example” section of the present disclosure.

For example, in one embodiment, the overlap of the social network of the two users may be employed when calculating similarity, such that that similarity measure between two users is a combined measure of both financial and social similarity. The overlap of social similarity may be obtained, for example, using a cosine calculation, in which a vector space is employed in which each user represents a basis vector. A direct connection between a given user and another user may be represented by a unit value along a basis vector associated with the other user, while a second order connection (through a direct connection) may be represented by a smaller value along a basis vector associated with the other user.

In some embodiments, the calculation of a similarity measured may include both financial and social attributes, such that a similarity measure is obtained that is a joint measure of financial and social similarity. For example, when performing a similarity calculation employing cosine similarity, elements of the vectors may include both financial category measures, and measures associated with the social network of the given user (for example, using a vector approach as described above), such that the cosine similarity calculation produces a net measure of financial and social similarity. The financial and social components of each vector may be multiplied by weights in order to control the relative impact of financial similarity and social similarity on the calculation of the composite similarity measure. In another example embodiment, separate measures of financial and social similarity between two users may be obtained, and subsequently combined (e.g. via addition, multiplication, averaging or weighted averaging) to obtain a composite similarity measure.

It is noted that the aforementioned methods of calculating financial similarity among users may be employed to identify a correlation-based user cohort, where the cohort is generated based on the subset of users that exceed a pre-selected similarity measure.

### Notifications and Alerts

FIG. 15 is a flow chart illustrating an example method 1500 for sending notifications (e.g. alerts). Notifications may take the form of emails, text messages (SMS), instant messages (IM), or mobile device push notifications, among other forms. The information in the notification may be any trade activity or financial information, and may be generated using a method similar that employed by the feed generation engine, as described above. As an example, a notification may include a mobile device push notification to a user stating that their social contact purchased a stock XYZ.

As described above within the context of feed item generation, a notification may also include relevancy indications that identify the relevance of a given notification to the user.

At step 1505 the notification system receives or otherwise obtains data or information associated with an event, which is henceforth referred to as an “item”. An item may be a feed item that has been generated by the feed generation engine, as described above. Example feed items for a specified user include, but are not limited to: a recent trade executed by the user's social contact; a large trend across investors similar to the user; the latest earning announcement in a stock that the user owns. In general, an item could be any event associated with trade activity or any financial news.

At step 1510 each item is ranked using the ranking engine and/or other ranking algorithms, calculations or heuristics, as described above for the ranking of feed items. A numerical relevance score is assigned to the item.

At step 1515 the item's relevance score is compared to a specified threshold for sending notifications. The notification system may also check other rules, which may include, but are not limited to, rules governing the user's notification preferences, rules governing how many notifications the user has received in a given period of time, etc. If the item's relevance exceeded the threshold and passes the given rules, the notification is allowed.

At step 1520, if step 1515 succeeds in allowing a notification, the notification is then delivered to the user, as shown at 1525, via a notification method that may include: email, text message or push notification, among other methods.

### Advertising

In another example embodiment of the present disclosure, the financial social network can be used to distribute, promote, advertise or market specific investments on behalf of third party interests. These promoted investments could be targeted to specific users based on their financial history and social network, much like how internet advertisements are targeted to specific users based on web browsing history and social network connections.

This system would first identify attributes describing the potential investment. These attributes could include, but are not limited to, descriptive features such as the category/industry focus of the investment, the risk associated with the investment, the historical performance of the investment.

The financial data pertaining to users of the financial network can then be searched to see if they own investments or groups of investments with similar features. For example, a similarity calculation may be employed to identify users for which the set of attributes generates a financial similarity measure that exceeds a pre-selected threshold for one or more securities (or for the overall holdings of the users).

Users who have investments with similar features (i.e. users who own securities that are financially similar to the attributes, or aggregate portfolio holdings are financially similar to the attributes) could then be targeted for promotional messaging associated with the investment that is characterized by the attributes. In one example implementation, this promoted investment could be displayed as a feed item within the financial feed, or could be communicated via email, text message, SMS message, or mobile device push notification.

As an example, supposed mutual fund XYZ wanted to market their technology focused, high risk fund XXX to the users of the financial social network. Investment XXX could be analyzed for features describing the investment. One feature would describe the investment as technology focused; another feature would describe the investment as high risk. The financial social network could then be search for users with existing high risk technology investments. Those users would then be shown the promoted investment in fund XXX.

An example method for determining which users to target for the investment would be to generate or import one or more target portfolios or categories from a third party. The server could compute a financial similarity value between the one or more target portfolios or categories and the users in the financial social network using the similarity calculations described herein. Users with a threshold value of financial similarity can be notified of the investment. Furthermore, the server could import social characteristics from users in the financial social database such as, but not limited to, demographics, educational background, religious beliefs, marital status, age, occupational information, gender. The third party could further narrow the list of recipient users based upon these traits. Furthermore, the server could import or generate portfolio metrics such as, but not limited to, beta, NAV, volatility, VAR, Sharpe ratio, dividend yield and distribution yield. The third party could further narrow the list of recipient users based upon these traits. The server could only run a financial similarity calculation on users that satisfy the abovementioned social characteristics or portfolio metrics.

A further understanding of an example embodiments of financial similarity and social similarity calculations can be drawn from the following non-limiting examples:

### SOCIAL SIMILARITY EXAMPLE 1

Three users, User A, User B and User C populate a social network. User B is socially connected with User A and User C, however, User A and User C are not socially connected. In one embodiment, the server database will generate an array or list containing the two immediate social connections in this network: AB, BA and BC, CB.

With respect to User B, without any additional social connections in this social network, the social similarity calculation can generate equal social similarity values for social connections BA and BC. In this case the shortest social connection path for either case is 1.

With respect to User A, without any additional social connections in this social network, the social similarity calculation can generate a higher value of social similarity for connection AB than for the connection AC, the combination of connection AB and BC. In this case the shortest social connection path for AB is 1 whereas that of AC is 2.

### SOCIAL SIMILARITY EXAMPLE 2

Four users, User A, User B, User C and User D populate a social network. Users A, B and C are all socially connected to one another. Furthermore, User D is socially connected to users B and C. In one embodiment, the server database will generate an array or list containing the immediate social connections in this network: AB, BA; BC, CB; CA, AC; DB, BD and BC, CB.

With respect to User B, without any additional social connections in this network, the social similarity calculation can generate equal values of social similarity for connection BC and BD. Both connections involve an immediate social connection, described as the shortest social connection path, and one additional first degree mutual social contact. A mutual social contact can be described as an intermediate user in a series of social connections with at least one intermediate user. A first degree mutual social contact is an intermediate user in a series of social connections wherein there is exactly one intermediate user.

Again, with respect to User B, without any additional social connections in this network, the social similarity calculation can generate a higher value of social similarity for connections BC and BD than for connection BA. Although, the shortest social connection path for all three connections is equal to 1, the server can be programmed to further manipulate the social similarity score based on mutual social contact connections. The program can be extended to search for a selected number of degrees of mutual social contacts.

### FINANCIAL SIMILARITY EXAMPLE 1

Three users, User A, User B and User C populate a financial social network of users. Users A and B both have portfolios containing only stock XXX and User C has a portfolio containing only stock YYY.

The financial similarity calculation can generate a higher value of financial similarity between Users A and B than between Users A and C or Users B and C. In an example embodiment of the present disclosure, each user will have a financial vector generate based on the holding of their portfolios. For example, this financial social network can be represented on the server by 2 dimensional vectors for each user normalized to describe the relative position sized of stocks in the portfolio. The first component of the vector can represent the relative value weight of stock XXX in a portfolio of a user in this network and the second component can represent the relative value of weight of stock YYY such that the following example vectors are generated:

$$A = ( \begin{matrix}1 \\ 0\end{matrix} ) B = ( \begin{matrix}1 \\ 0\end{matrix} ) C = ( \begin{matrix}0 \\ 1\end{matrix} )$$

Financial similarity can then be computed by taking the inner product of two users. In this case, the financial similarity between users A and B is assigned a higher value than that of A and C or B and C.

### FINANCIAL SIMILARITY EXAMPLE 2

Three users, User A, User B and User C populate a financial social network of users. Users A has a portfolio containing only stock XXX, User B has a portfolio containing only stock YYY and User C has a portfolio containing only stock ZZZ. However, the server has organized stocks XXX and YYY into the list of stocks stored under the category “tech stocks” whereas stock ZZZ is stored under the category “financial stocks.”

In this network, the calculation described in the financial similarity example 1 would return an equally null value for the financial similarity between the three users. However, a further calculation can be used to assign a higher value of financial similarity between users A and B who are both holding stocks in the same category than between users A and C or B and C. Rather than the three independent components required by the previous example the dimensionality of the financial vectors generated for Users A, B and C can be reduced to two components, one for each category, resulting in the following vectors:

$$A = ( \begin{matrix}1 \\ 0\end{matrix} ) B = ( \begin{matrix}1 \\ 0\end{matrix} ) C = ( \begin{matrix}0 \\ 1\end{matrix} )$$

Again, the financial similarity calculation can take the inner product between two users' financial vectors to generate a level of financial similarity.

The abovementioned examples use a cosine similarity calculation; however, a Jaccardian similarity calculation can be used. In this case similarity is determined as a ratio of the number of securities belonging to a similar category divided by the size of the union of the different securities held in the portfolios between two users.

While some embodiments can be implemented in fully functioning computers and computer systems, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

1. A system for processing and distributing financial information to users of a financial social network, the system comprising:
a plurality of user computing devices, each user computing device associated a respective user of the financial social network, each user computing device comprising computer hardware configured to display a user interface for receiving input from a respective user and for presenting information associated with transactions associated with users of the financial social network;
a user transaction database comprising user transaction data associating transactions with users of the financial social network;
a remote server connectable to each user computing device through a communications network, wherein said user transaction database accessible by said remote server, said server comprising computer hardware configured to:
receive data transmissions from an active user computing device associated with an active user, the data transmissions comprising input received on the active user computing device, the input identifying a selected security;
access, from the user transaction database, user transaction data associating transactions with users of the financial social network;
process the user transaction data to identify one or more matching transactions involving the selected security, wherein each matching transaction is associated with a respective matching user;
obtain historical data associated with the selected security;
generate annotated time-dependent plot data based on the one or more matching transactions for rendering an annotated time-dependent plot of the historical data associated with the selected security on a user interface associated with the active user, such that the annotated time-dependent plot of the historical data includes one or more graphical annotations representative of the one or more matching transactions, and such that the plot comprises at least two dimensions; and
transmit the annotated time-dependent plot data to the active user computing device for rendering on the user interface thereof.

2. The system according to claim 1 wherein said remote server is further configured to filter the matching transactions according to at least one criterion.

3. The system according to claim 2 wherein said remote server is further configured such that at least one criterion comprises a threshold number of degrees of social connectivity relative to the active user.

4. The system according to claim 2 wherein said remote server is further configured such that at least one criterion comprises a threshold associated with a performance metric measure.

5. The system according to claim 2 wherein said remote server is further configured such that at least one criterion comprises a time window during which transactions were executed.

6. The system according to claim 2 wherein said remote server is further configured such that at least one criterion is provided by the input.

7. The system according to claim 2 wherein said remote server is further configured to generate the annotated time-dependent plot data such that two or more matching users' prior transactions are aggregated into a single combined graphical annotation.

8. The system according to claim 1 wherein said remote server is further configured to generate the annotated time-dependent plot data such that two or more matching transactions are represented by an aggregate graphical annotation when the two or more matching transactions occur within a prescribed time interval.

9. The system according to claim 1 wherein said remote server is further configured to generate the annotated time-dependent plot data such that at least one graphical annotation is configured to identify the matching user associated therewith.

10. The system according to claim 9 wherein said remote server is further configured to generate the annotated time-dependent plot data such that at least one graphical annotation comprises one or more of a textual user identifier, user icon, user avatar, and user profile picture.

11. The system according to claim 1 wherein the historical data associated with the security is selected from the group consisting of price data and volume data.

12. The system according to claim 1 wherein said remote server is further configured to generate the annotated time-dependent plot data such that the annotated time-dependent plot is an annotated price chart.

13. The system according to claim 12 wherein said remote server is further configured to generate the annotated time-dependent plot data such that at least one graphical annotation is configured to be displayed on the annotated time-dependent plot at a time and at a price corresponding to a matching transaction associated therewith.

14. The system according to any claim 1 wherein said remote server is further configured to:
obtain social media metadata provided by users of the financial social network;
process the social media metadata to identify one or more matching social media metadata events involving the selected security, wherein each matching social media metadata event is associated with a respective matching user; and
wherein said remote server is further configured to generate the annotated time-dependent plot data such that the annotated time-dependent plot data is further generated based on the one or more matching social media metadata events, such that the annotated time-dependent plot includes one or more additional graphical annotations representative of the one or more matching social media metadata events.

15. The system according to claim 1 wherein at least one transaction is a simulated transaction.

16-18. (canceled)

19. A system for processing and distributing financial information to users of a financial social network, the system comprising:
a plurality of user computing devices, each user computing device associated a respective user of the financial social network, each user computing device comprising computer hardware configured to display a user interface for receiving input from a respective user and for presenting information associated with transactions associated with users of the financial social network;
a user transaction database comprising user transaction data associating transactions with users of the financial social network;
a remote server connectable to each user computing device through a communications network, wherein said user transaction database accessible by said remote server, said server comprising computer hardware configured to:
receive data transmissions from an active user computing device associated with an active user, the data transmissions comprising input received on the active user computing device, the input identifying a selected security;
access, from the user transaction database, user transaction data associating transactions with users of the financial social network;
obtain historical data associated with the selected security;
process the user transaction data to identify one or more matching transactions involving the selected security, wherein each matching transaction is associated with a respective matching user of the financial social network;
generate matching transaction data comprising the matching transactions, the historical data, and the associated matching users to the active computing device;
wherein said active user computing device is configured to receive the matching transaction data and generate and render an annotated time-dependent plot of the historical data on the user interface, such that the plot comprises at least two dimensions.

20. (canceled)

21. A system for processing and distributing financial information to users of a financial social network, the system comprising:
a plurality of user computing devices, each user computing device associated a respective user of the financial social network, each user computing device comprising computer hardware configured to display a user interface for receiving input from a respective user and for presenting information associated with transactions associated with users of the financial social network;
a user transaction database comprising user transaction data associating transactions with users of the financial social network;
a remote server connectable to each user computing device through a communications network, wherein said user transaction database accessible by said remote server, said server comprising computer hardware configured to:
receive data transmissions from an active user computing device associated with an active user, the data transmissions comprising input received on the active user computing device, the input identifying a selected financial index:
access, from the user transaction database, user transaction data associating transactions with users of the financial social network;
obtain historical data associated with the selected financial index;
process the user transaction data processing the user transaction data to identify one or more matching transactions involving the selected financial index, wherein each matching transaction is associated with a respective matching user of the financial social network, wherein the financial index comprises a plurality of financial securities, and wherein the one or more matching transactions involve one or more financial securities of the plurality of financial securities; and
generate annotated time-dependent plot data for rendering an annotated time-dependent plot of the historical data associated with the selected financial index on a user interface associated with the active user, wherein the annotated time-dependent plot data is generated based on the one or more matching transactions, such that the annotated time-dependent plot of the historical data includes one or more graphical annotations representative of the one or more matching transactions, and such that the plot comprises at least two dimensions; and
transmit the annotated time-dependent plot data to the active user computing device for rendering on the user interface thereof.

22. The system according to claim 21 wherein said remote server is further configured such that the financial index is generated by processing the user transaction data according to at least one selection criterion, such that the financial index is formed based on the investment positions of users of the financial social network.

23. The system according to claim 21 wherein said remote server is further configured such that at least one selection criterion is a performance criterion.

24. (canceled)

25. The computer implemented method according to claim 1 wherein the active user computing device is configured to render the annotated time-dependent plot such that information identifying a given user associated with a given matching transaction is displayed to the active user when additional input is provided by the active user, the additional input identifying a spatial location on the annotated time-dependent plot associated with the given matching transaction.

26.-84. (canceled)
